(19) United States
(12) Patent Application Publication
(10) Pub. No.: US 2025/0236763 A1
(43) Pub. Date: Jul. 24, 2025

(54) COMPOSITION, SUBSTRATE WITH SURFACE LAYER, AND METHOD FOR PRODUCING SUBSTRATE WITH SURFACE LAYER

(71) Applicant: AGC INC., Tokyo (JP)

(72) Inventors: Takuya IWASE, Tokyo (JP); Hikaru ONO, Tokyo (JP); Motoshi AOYAMA, Tokyo (JP)

(73) Assignee: AGC INC., Tokyo (JP)

(21) Appl. No.: 19/174,068

(22) Filed: Apr. 9, 2025

Related U.S. Application Data
(63) Continuation of application No. PCT/JP2023/036909, filed on Oct. 11, 2023.

(30) Foreign Application Priority Data
Oct. 13, 2022 (JP) 2022-164546

(51) Int. Cl. C09D 183/12; C09D 171/02

(52) U.S. Cl. CPC C09D 183/12; C09D 171/02

(57) ABSTRACT

To provide a composition from which a surface layer excellent in abrasion resistance can be formed, a substrate with a surface layer, and a method for producing a substrate with a surface layer. A composition containing a first component composed of at least one fluorinated ether compound selected from the group consisting of a compound represented by the formula (A1), a compound represented by the formula (A2) and a compound represented by the formula (A3), and a second component composed of at least one fluorinated ether compound selected from the group consisting of a compound represented by the formula (B1) and a compound represented by the formula (B2).

### TECHNICAL FIELD

The present invention relates to a composition, a substrate with a surface layer, and a method for producing a substrate with a surface layer.

### BACKGROUND ART

It is known to form a surface layer formed of a condensate of a fluorinated ether compound having a poly(oxyperfluoroalkylene) chain and a hydrolysable silyl group, on the surface of a substrate by surface treatment using the fluorinated ether compound, so as to impart water/oil repellency, fingerprint removability, lubricity (smoothness when touched with fingers), etc., on the surface of the substrate (Patent Document 1).

### PRIOR ART DOCUMENTS

### Patent Documents

Patent Document 1: WO2017/022437

### DISCLOSURE OF INVENTION

### Technical Problem

In recent years, requirement for performance of a surface layer formed by using a fluorinated ether compound is becoming high. For example, in an application to a member constituting a surface to be touched with fingers, required is a surface layer of which performance (for example water repellency) is hardly reduced even when repeatedly rubbed, that is a surface layer excellent in abrasion resistance.

The present inventors have evaluated a surface layer formed by using a fluorinated ether compound as described in Patent Document 1 and as a result found that the abrasion resistance of the surface layer can still be improved.

Under these circumstances, the object of the present invention is to provide a composition from which a surface layer excellent in abrasion resistance can be formed, a substrate with a surface layer, and a method for producing a substrate with a surface layer.

### Solution to Problem

The present inventors have found that the above object can be achieved by the following construction.

[1] A composition containing:
a first component composed of at least one fluorinated ether compound selected from the group consisting of a compound represented by the formula (A1), a compound represented by the formula (A2) and a compound represented by the formula (A3), and
a second component composed of at least one fluorinated ether compound selected from the group consisting of a compound represented by the formula (B1) and a compound represented by the formula (B2),

[R^{f1}—(OR^{f11})_{y1}—O—R¹]ⱼ-L¹-(R¹¹-T¹¹)ₓ₁ (A1)

(T³¹-R³¹)ₓ₃-L³-R³—(OR^{f12})_{y2}—O—R²-L²-(R²¹-T²¹)ₓ₂ (A2)

Q¹[-(OR^{f13})_{y3}—O—R⁴-L⁴-(R⁴¹-T⁴¹)ₓ₄]ᵣ₁ (A3)

R^{f14}—(OR^{f15})_{y4}—O—R⁵—R^{b1} (B1)

R^{f19}—(OR^{f18})_{y6}—O—R⁷-L^{b1}-R⁶—O—(R^{f16}O)_{y5}—R^{f17} (B2)
in the formula (A1),
R^{f1} is a C₁₋₂₀ fluoroalkyl group, and when there is a plurality of R^{f1}, the plurality of R^{f1} may be the same or different from each other,
R^{f11} is a C₁₋₆ fluoroalkylene group, and when there is a plurality of R^{f11}, the plurality of R^{f11} may be the same or different from each other,
R¹ is an alkylene group or a fluoroalkylene group, and when there is a plurality of R¹, the plurality of R¹ may be the same or different from each other,
L¹ is a single bond or a (j+x1)-valent group which may have N, O, S or Si and may have a branch point, and in which atoms bonded to R¹ and R¹¹ are each independently N, O, S, Si, a carbon atom constituting the branch point, or a carbon atom having a hydroxy group or an oxo group (═O),
R¹¹ is an alkylene group in which an atom bonded to L¹ may be an etheric oxygen atom, and which may have an etheric oxygen atom between carbon atoms, and when there is a plurality of R¹¹, the plurality of R¹¹ may be the same or different from each other,
T¹¹ is —SiR^{a11}_{z11}R^{a12}_{3-z11}, and when there is a plurality of T¹¹, the plurality of T¹¹ may be the same or different from each other,
R^{a11} is a hydroxy group or a hydrolysable group, and when there is a plurality of R^{a11}, the plurality of R^{a11} may be the same or different from each other,
R^{a12} is a non-hydrolysable group, and when there is a plurality of R^{a12}, the plurality of R^{a12} may be the same or different from each other,
j is an integer of 1 or more, and when j is 1, y1 is an integer of 2 or more, or R¹ is a fluoroalkylene group,
z11 is an integer of 1 to 3,
x1 is an integer of 1 or more, and
y1 is an integer of 1 or more, and when there is a plurality of y1, the plurality of y1 may be the same or different from each other,
in the formula (A2),
R^{f12} is a C₁₋₆ fluoroalkylene group, and when there is a plurality of R^{f12}, the plurality of R^{f12} may be the same or different from each other,
R² and R³ are each independently an alkylene group or a fluoroalkylene group,
L² is a single bond or a (1+x2)-valent group which may have N, O, S or Si and may have a branch point, and in which atoms bonded to R² and R²¹ are each independently N, O, S, Si, a carbon atom constituting the branch point, or a carbon atom having a hydroxy group or an oxo group,
L³ is a single bond or a (1+x3)-valent group which may have N, O, S or Si and may have a branch point, and in which atoms bonded to R³ and R³¹ are each independently N, O, S, Si, a carbon atom constituting the branch point, or a carbon atom having a hydroxy group or an oxo group,
R²¹ is an alkylene group in which an atom adjacent to L² may be an etheric oxygen atom, and which may have an etheric oxygen atom between carbon atoms, and when there is a plurality of R²¹, the plurality of R²¹ may be the same or different from each other,
R³¹ is an alkylene group in which an atom adjacent to L³ may be an etheric oxygen atom, and which may have an etheric oxygen atom between carbon atoms, and when there is a plurality of R³¹, the plurality of R³¹ may be the same or different from each other,
T²¹ and T³¹ are each independently —SiR^{a21}_{z21}R^{a22}_{3-z21}, when there is a plurality of T²¹, the plurality of T²¹ may be the same or different from each other, and when there is a plurality of T³¹, the plurality of T³¹ may be the same or different from each other,
R^{a21} is a hydroxy group or a hydrolysable group, and when there is a plurality of R^{a21}, the plurality of R^{a21} may be the same or different from each other,
R^{a22} is a non-hydrolysable group, and when there is a plurality of R^{a22}, the plurality of R^{a22} may be the same or different from each other,
z21 is an integer of 1 to 3,
x2 and x3 are each independently an integer of 1 or more, and
y2 is an integer of 1 or more, and when y2 is 1, R² is a fluoroalkylene group,
in the formula (A3),
Q¹ is a r1-valent group having a branch point,
R^{f13} is a C₁₋₆ fluoroalkylene group, and the plurality of R^{f13} may be the same or different from each other,
R⁴ is each independently an alkylene group or a fluoroalkylene group, and the plurality of R⁴ may be the same or different from each other,
L⁴ is a single bond or a (1+x4)-valent group which may have N, O, S or Si and may have a branch point, and in which atoms bonded to R⁴ and R⁴¹ are each independently N, O, S, Si, a carbon atom constituting the branch point, or a carbon atom having a hydroxy group or an oxo group, and the plurality of L⁴ may be the same or different from each other,
R⁴¹ is an alkylene group in which an atom adjacent to L⁴ may be an etheric oxygen atom, and which may have an etheric oxygen atom between carbon atoms, and the plurality of R⁴¹ may be the same or different from each other,
T⁴¹ is —SiR^{a41}_{z41}R^{a42}_{3-z41}, and the plurality of T⁴¹ may be the same or different from each other,
R^{a41} is a hydroxy group or a hydrolysable group, and the plurality of R^{a41} may be the same or different from each other,
R^{a42} is a non-hydrolysable group, and when there is a plurality of R^{a42}, the plurality of R^{a42} may be the same or different from each other,
z41 is an integer of 1 to 3,
x4 is an integer of 1 or more, and when there is a plurality of x4, the plurality of x4 may be the same or different from each other,
y3 is an integer of 1 or more, and when there is a plurality of y3, the plurality of y3 may be the same or different from each other, and
r1 is 3 or 4,
in the formula (B1),
R^{f14} is a C₁₋₂₀ fluoroalkyl group,
R^{f15} is a C₁₋₆ fluoroalkylene group, and when there is a plurality of R^{f15}, the plurality of R^{f15} may be the same or different from each other,
R⁵ is an alkylene group which may have a substituent,
R^{b1} is a hydrogen atom, a chlorine atom, a bromine atom, or an iodine atom, and
y4 is an integer of 1 or more,
in the formula (B2),
R^{f17} and R^{f19} are each independently a C₁₋₂₀ fluoroalkyl group,
R^{f16} and R^{f18} are each independently a C₁₋₆ fluoroalkylene group, when there is a plurality of R^{f16}, the plurality of R^{f16} may be the same or different from each other, and when there is a plurality of R^{f18}, the plurality of R^{f18} may be the same or different from each other,
R⁶ and R⁷ are each independently an alkylene group which may have a substituent,
L^{b1} is a single bond or a bivalent linking group (excluding (OR^{f18})_{y7} and (R^{f16}O)_{y8}, y7 and y8 are each independently an integer of 1 or more), and
y5 and y6 are each independently an integer of 1 or more.
   [2] The composition according to [1], wherein
in the formula (A1), at least one R¹¹ has a carbon chain having 4 or more carbon atoms linked to one another and the carbon chain is linked to T¹¹,
in the formula (A2), at least one of the following conditions is satisfied that at least one R²¹ has a carbon chain having 4 or more carbon atoms linked to one another and the carbon chain is linked to T²¹; and at least one R³¹ has a carbon chain having 4 or more carbon atoms linked to one another and the carbon chain is linked to T³¹, and
in the formula (A3), at least one R⁴¹ has a carbon chain having 4 or more carbon atoms linked to one another and the carbon chain is linked to T⁴¹.
   [3] The composition according to [1] or [2], wherein a mass ratio of a content of the second component to a content of the first component is 0.01 to 0.50.
   [4] The composition according to any one of [1] to [3], wherein
in the formula (B1), R⁵ is a fluoroalkylene group, and
in the formula (B2), both R⁶ are R⁷ are a fluoroalkylene group, and L^{b1} is a single bond.
   [5] The composition according to [4], wherein
in the formula (B1), a number of carbon atoms in the fluoroalkylene group represented by R⁵ is 1 to 20, and
in the formula (B2), a sum of a number of carbon atoms in the fluoroalkylene group represented by R⁶ and a number of carbon atoms in the fluoroalkylene group represented by R⁷ is 2 to 40.
   [6] A substrate with a surface layer, which comprises a substrate and a surface layer formed of the composition as defined in any one of [1] to [5] on the substrate.
   [7] A method for producing a substrate with a surface layer, which comprises forming a surface layer on a substrate using the composition as defined in any one of [1] to [5] by dry coating method or wet coating method.

### Advantageous Effects of Invention

According to the present invention, provided are a composition from which a surface layer excellent in abrasion resistance can be formed, a substrate with a surface layer, and a method for producing a substrate with a surface layer.

### DESCRIPTION OF EMBODIMENTS

In this specification, a compound represented by the formula (B1) will be referred to as Compound (B1). The same applies to compounds represented by other formulae. Repeating units represented by the formula (f1) will be referred to as units (f1). The same applies to units represented by other formulae. A group represented by the formula (g1) will be referred to as group (g1). The same applies to groups represented by other formulae.

A “fluoroalkyl group” generically means a perfluoroalkyl group and a partial fluoroalkyl group. The perfluoroalkyl group means an alkyl group in which all hydrogen atoms are replaced with fluorine atoms. The partial fluoroalkyl group means an alkyl group in which 1 or more hydrogen atoms are replaced with fluorine atoms and which has 1 or more hydrogen atoms. That is, the fluoroalkyl group is an alkyl group having 1 or more fluorine atoms.

A “reactive silyl group” generically means a hydrolysable silyl group and a silanol group (Si—OH), and the “hydrolysable silyl group” means a group capable of forming a silanol group when hydrolyzed.

An “organic group” manes a hydrocarbon group which may have a substituent and which may have a hetero atom or another bond in a carbon chain.

A “hydrocarbon group” is a group composed of carbon atoms and hydrogen atoms and is an aliphatic hydrocarbon group (for example, a bivalent aliphatic hydrocarbon group may be a linear alkylene group, an alkylene group having a branch or a cycloalkylene group), an aromatic hydrocarbon group (for example, a bivalent aromatic hydrocarbon group may be a phenylene group) or a combination thereof.

A “surface layer” means a layer to be formed on the surface of a substrate.

A “molecular weight” of a partial structure of e.g. a fluoroether chain or a fluoropolyether chain or a fluorinated ether compound is a number average molecular weight calculated from the number (average) of oxyfluoroalkylene units based on the terminal groups by means of ¹H-NMR and ¹⁹F-NMR.

“To” representing a range of numerical values means to include numerical values before and after it as the lower limit value and the upper limit value.

### [Composition]

The composition of the present invention contains a first component composed of at least one fluorinated ether compound selected from the group consisting of a compound represented by the formula (A1) described later, a compound represented by the formula (A2) described later and a compound represented by the formula (A3) described later, and a second component composed of at least one fluorinated ether compound selected from the group consisting of a compound represented by the formula (B1) described later and a compound represented by the formula (B2) described later.

The present inventors have found that when a surface layer is formed on a substrate by using the composition of the present invention, the surface layer has improved water repellency and abrasion resistance. The detailed mechanism has not been clearly understood yet, but is considered that the composition containing the specific first component and the specific second component greatly contributes to development of the effects.

### <First Component>

The first component contained in the composition of the present invention is at least one fluorinated ether compound selected from the group consisting of a compound represented by the formula (A1), a compound represented by the formula (A2) and a compound represented by the formula (A3).

[R^{f1}—(OR^{f11})_{y1}—O—R¹]ⱼ-L¹-(R¹¹-T¹¹)ₓ₁ (A1)

(T³¹-R³¹)ₓ₃-L³-R³—(OR^{f12})_{y2}—O—R²-L²-(R²¹-T²¹)ₓ₂ (A2)

Q¹[-(OR^{f13})_{y3}—O—R⁴-L⁴-(R⁴¹-T⁴¹)ₓ₄]ᵣ₁ (A3)

In the formula (A1),
R^{f1} is a C₁₋₂₀ fluoroalkyl group, and when there is a plurality of R^{f1}, the plurality of R^{f1} may be the same or different from each other,
R^{f11} is a C₁₋₆ fluoroalkylene group, and when there is a plurality of R^{f11}, the plurality of R^{f11} may be the same or different from each other,
R¹ is an alkylene group or a fluoroalkylene group, and when there is a plurality of R¹, the plurality of R¹ may be the same or different from each other,
L¹ is a single bond or a (j+x1)-valent group which may have N, O, S or Si and may have a branch point, and in which atoms bonded to R¹ and R¹¹ are each independently N, O, S, Si, a carbon atom constituting the branch point, or a carbon atom having a hydroxy group or an oxo group (═O),
R¹¹ is an alkylene group in which an atom bonded to L¹ may be an etheric oxygen atom, and which may have an etheric oxygen atom between carbon atoms, and when there is a plurality of R¹¹, the plurality of R¹¹ may be the same or different from each other,
T¹¹ is —SiR^{a11}_{z11}R^{a12}_{3-z11}, and when there is a plurality of T¹¹, the plurality of T¹¹ may be the same or different from each other,
R^{a11} is a hydroxy group or a hydrolysable group, and when there is a plurality of R^{a11}, the plurality of R^{a11} may be the same or different from each other,
R^{a12} is a non-hydrolysable group, and when there is a plurality of R^{a12}, the plurality of R^{a12} may be the same or different from each other,
j is an integer of 1 or more, and when j is 1, y1 is an integer of 2 or more, or R¹ is a fluoroalkylene group,
z11 is an integer of 1 to 3,
x1 is an integer of 2 or more, and
y1 is an integer of 1 or more, and when there is a plurality of y1, the plurality of y1 may be the same or different from each other.

In the formula (A2),
R^{f12} is a C₁₋₆ fluoroalkylene group, and when there is a plurality of R^{f12}, the plurality of R^{f12} may be the same or different from each other,
R² and R³ are each independently an alkylene group or a fluoroalkylene group,
L² is a single bond or a (1+x2)-valent group which may have N, O, S or Si and may have a branch point, and in which atoms bonded to R² and R²¹ are each independently N, O, S, Si, a carbon atom constituting the branch point, or a carbon atom having a hydroxy group or an oxo group,
L³ is a single bond or a (1+x3)-valent group which may have N, O, S or Si and may have a branch point, and in which atoms bonded to R³ and R³¹ are each independently N, O, S, Si, a carbon atom constituting the branch point, or a carbon atom having a hydroxy group or an oxo group,
R²¹ is an alkylene group in which an atom adjacent to L² may be an etheric oxygen atom, and which may have an etheric oxygen atom between carbon atoms, and when there is a plurality of R²¹, the plurality of R²¹ may be the same or different from each other,
R³¹ is an alkylene group in which an atom adjacent to L³ may be an etheric oxygen atom, and which may have an etheric oxygen atom between carbon atoms, and when there is a plurality of R³¹, the plurality of R³¹ may be the same or different from each other,
T²¹ and T³¹ are each independently —SiR^{a21}_{z21}R^{a22}_{3-z21}, when there is a plurality of T²¹, the plurality of T²¹ may be the same or different from each other, and when there is a plurality of T³¹, the plurality of T³¹ may be the same or different from each other,
R^{a21} is a hydroxy group or a hydrolysable group, and when there is a plurality of R^{a21}, the plurality of R^{a21} may be the same or different from each other,
R^{a22} is a non-hydrolysable group, and when there is a plurality of R^{a22}, the plurality of R^{a22} may be the same or different from each other,
z21 is an integer of 1 to 3,
x2 and x3 are each independently an integer of 2 or more, and
y2 is an integer of 1 or more, and when y2 is 1, R² is a fluoroalkylene group.

In the formula (A3),
Q¹ is a r1-valent group having a branch point,
R^{f13} is a C₁₋₆ fluoroalkylene group, and the plurality of R^{f13} may be the same or different from each other,
R⁴ is each independently an alkylene group or a fluoroalkylene group, and the plurality of R⁴ may be the same or different from each other,
L⁴ is a single bond or a (1+x4)-valent group which may have N, O, S or Si and may have a branch point, and in which atoms bonded to R⁴ and R⁴¹ are each independently N, O, S, Si, a carbon atom constituting the branch point, or a carbon atom having a hydroxy group or an oxo group, and the plurality of L⁴ may be the same or different from each other,
R⁴¹ is an alkylene group in which an atom adjacent to L⁴ may be an etheric oxygen atom, and which may have an etheric oxygen atom between carbon atoms, and the plurality of R⁴¹ may be the same or different from each other,
T⁴¹ is —SiR^{a41}_{z41}R^{a42}_{3-z41}, and the plurality of T⁴¹ may be the same or different from each other,
R^{a41} is a hydroxy group or a hydrolysable group, and the plurality of R^{a41} may be the same or different from each other,
R^{a42} is a non-hydrolysable group, and when there is a plurality of R^{a42}, the plurality of R^{a42} may be the same or different from each other,
z41 is an integer of 1 to 3,
x4 is an integer of 2 or more, and the plurality of x4 may be the same or different from each other,
y3 is an integer of 1 or more, and the plurality of y3 may be the same or different from each other, and
r1 is 3 or 4.

Now, structures of the respective compounds will be described. Reference symbols representing the same structures are indicated as such and may properly be read for reference.

Since a reactive silyl group is firmly chemically bonded to a substrate, a surface layer formed by using a first component having a reactive silyl group at its terminal is excellent in durability such as abrasion resistance.

The fluoropolyether chain is a group having 2 or more oxyfluoroalkylene units.

The fluoropolyether chain may have a hydrogen atom. In order that an obtainable surface layer will be more excellent in abrasion resistance and fingerprint removability, the proportion of fluorine atoms represented by the following formula (I) in the fluoropolyether chain is preferably 60% or more, more preferably 80% or more, further preferably substantially 100%, that is the fluoropolyether chain is a perfluoropolyether chain. When the proportion of fluorine atoms is 60% or more, the fluorine amount in the fluoropolyether chain is large, and lubricity and fingerprint removability will more improve.

proportion of fluorine atoms (%)=(number of fluorine atoms)/{(number of fluorine atoms)+(number of hydrogen atoms)}×100 Formula (I):

The molecular weight of one fluoropolyether chain is, in order that the obtainable surface layer has both fingerprint removability and lubricity, preferably 2,000 to 20,000, more preferably 2,500 to 15,000, further preferably 3,000 to 10,000. When the molecular weight of the fluoropolyether chain is 2,000 or more, the fluoropolyether chain has improved flexibility and in addition, the fluorine amount in the molecule is large, whereby lubricity and fingerprint removability will further improve. On the other hand, when the molecular weight of the fluoropolyether chain is 20,000 or less, the obtainable surface layer will be more excellent in abrasion resistance.

### (Compound (A1))

The Compound (A1) has a structure represented by the following formula (A1).

[R^{f1}—(OR^{f11})_{y1}—O—R¹]ⱼ-L¹-(R¹¹-T¹¹)ₓ₁ (A1)

Symbols in the formula (A1) are as defined above.

R^{f1} is a C₁₋₂₀ fluoroalkyl group. The fluoroalkyl group may be linear, or may have a branch and/or a cyclic structure. In view of abrasion resistance, it is preferably a linear fluoroalkyl group, and in view of easiness of synthesis, etc., the number of carbon atoms in the fluoroalkyl group is preferably 1 to 6, more preferably 1 to 3.

R^{f11} is a C₁₋₆ fluoroalkylene group, and when there is a plurality of R^{f11}, the plurality of R^{f11} may be the same or different from each other. (OR^{f11})_{y1} represents a fluoroether chain or a fluoropolyether chain (a fluoroether chain when y1 is 1, and as described above, a fluoropolyether chain when y1 is 2 or more), and y1 is an integer of 1 or more and is preferably 1 to 200.

(OR^{f11})_{y1} preferably has a structure represented by the following formula (G11).

[(OG^{f1})ₘ₁(OG^{f2})ₘ₂(OG^{f3})ₘ₃(OG^{f4})ₘ₄(OG^{f5})ₘ₅(OG^{f6})ₘ₆]- (G11)
wherein
G^{f1} is a fluoroalkylene group having one carbon atom,
G^{f2} is a fluoroalkylene group having two carbon atoms,
G^{f3} is a fluoroalkylene group having three carbon atoms,
G^{f4} is a fluoroalkylene group having four carbon atoms,
G^{f5} is a fluoroalkylene group having five carbon atoms,
G^{f6} is a fluoroalkylene group having six carbon atoms,
m1, m2, m3, m4, m5 and m6 are each independently an integer of 0 or 1 or more, and m1+m2+m3+m4+m5+m6 is preferably an integer of 1 to 200.

In the formula (G11), the order of binding of (OG^{f1}) to (OG^{f6}) is optional. m1 to m6 in the formula (G11) respectively means the numbers of (OG^{f1}) to (OG^{f6}), not the arrangement. For example, (OG^{f5})ₘ₅ means that the number of (OG^{f5}) is m5, not a block arranged structure of (OG^{f5})ₘ₅. Likewise, the order of description of (OG^{f1}) to (OG^{f6}) does not represent the order of binding of the respective units.

The fluoroalkylene group having 3 to 6 carbon atoms may be a linear fluoroalkylene group, or may be a fluoroalkylene group having a branch or a cyclic structure.

Specific examples of G^{f1} include —CF₂—, and —CHF—.

Specific examples of G^{f2} include —CF₂CF₂—, —CHFCF₂—, —CHFCHF—, —CH₂CF₂—, and —CH₂CHF—.

Specific examples of G^{f3} include —CF₂CF₂CF₂—, —CF₂CHFCF₂—, —CF₂CH₂CF₂—, —CHFCF₂CF₂—, —CHFCHFCF₂—, —CHFCHFCHF—, —CHFCH₂CF₂—, —CH₂CF₂CF₂—, —CH₂CHFCF₂—, —CH₂CH₂CF₂—, —CH₂CF₂CHF—, —CH₂CHFCHF—, —CH₂CH₂CHF—, —CF(CF₃)—CF₂—, —CF(CHF₂)—CF₂—, —CF(CH₂F)—CF₂—, —CF(CH₃)—CF₂—, —CF(CF₃)—CHF—, —CF(CHF₂)—CHF—, —CF(CH₂F)—CHF—, —CF(CH₃)—CHF—, —CF(CF₃)—CH₂—, —CF(CHF₂)—CH₂—, —CF(CH₂F)—CH₂—, —CF(CH₃)—CH₂—, —CH(CF₃)—CF₂—, —CH(CHF₂)—CF₂—, —CH(CH₂F)—CF₂—, —CH(CH₃)—CF₂—, —CH(CF₃)—CHF—, —CH(CHF₂)—CHF—, —CH(CH₂F)—CHF—, —CH(CH₃)—CHF—, —CH(CF₃)—CH₂—, —CH(CHF₂)—CH₂—, and —CH(CH₂F)—CH₂—.

Specific examples of G^{f4} include —CF₂CF₂CF₂CF₂—, —CHFCF₂CF₂CF₂—, —CH₂CF₂CF₂CF₂—, —CF₂CHFCF₂CF₂—, —CHFCHFCF₂CF₂—, —CH₂CHFCF₂CF₂—, —CF₂CH₂CF₂CF₂—, —CHFCH₂CF₂CF₂—, —CH₂CH₂CF₂CF₂—, —CHFCF₂CHFCF₂—, —CH₂CF₂CHFCF₂—, —CF₂CHFCHFCF₂—, —CHFCHFCHFCF₂—, —CH₂CHFCHFCF₂—, —CF₂CH₂CHFCF₂—, —CHFCH₂CHFCF₂—, —CH₂CH₂CHFCF₂—, —CF₂CH₂CH₂CF₂—, —CHFCH₂CH₂CF₂—, —CH₂CH₂CH₂CF₂—, —CHFCH₂CH₂CHF—, —CH₂CH₂CH₂CHF—, and -cycloC₄F₆—.

Specific examples of G^{f5} include —CF₂CF₂CF₂CF₂CF₂—, —CHFCF₂CF₂CF₂CF₂—, —CH₂CHFCF₂CF₂CF₂—, —CF₂CHFCF₂CF₂CF₂—, —CHFCHFCF₂CF₂CF₂—, —CF₂CH₂CF₂CF₂CF₂—, —CHFCH₂CF₂CF₂CF₂—, —CH₂CH₂CF₂CF₂CF₂—, —CF₂CF₂CHFCF₂CF₂—, —CHFCF₂CHFCF₂CF₂—, —CH₂CF₂CHFCF₂CF₂—, —CH₂CF₂CF₂CF₂CH₂—, and -cycloC₅F₈—.

Specific examples of G^{f6} include —CF₂CF₂CF₂CF₂CF₂CF₂—, —CF₂CF₂CHFCHFCF₂CF₂—, —CHFCF₂CF₂CF₂CF₂CF₂—, —CHFCHFCHFCHFCHFCHF—, —CHFCF₂CF₂CF₂CF₂CH₂—, —CH₂CF₂CF₂CF₂CF₂CH₂—, and -cycloC₆F₁₀.

-cycloC₄F₆-means a perfluorocyclobutanediyl group, and its specific examples include a perfluorocyclobutene-1,2-diyl group. -cycloC₅F₈-means a perfluorocyclopentanediyl group and its specific examples include a perfluorocyclopentan-1,3-diyl group. -cycloC₆F₁₀-means a perfluorocyclohexanediyl group and its specific examples include a perfluorocyclohexan-1,4-diyl group.

(OR^{f11})_{y1} particularly preferably has a structure represented by any one of the following formulae (G2) to (G4), in view of more excellent water/oil repellency, abrasion resistance and fingerprint stain removability.

(OG^{f1})ₘ₁-(OG^{f2})ₘ₂ formula (G2)

(OG^{f2})ₘ₂-(OG^{f4})ₘ₄ formula (G3)

(OG^{f3})ₘ₃ formula (G4)

Symbols in the formulae (G2) to (G4) are as defined for the above formula (G11).

In the formulae (G2) and (G3), the orders of binding of (OG^{f1}) and (OG^{f2}), and (OG^{f2}) and (OG^{f4}), are respectively optional. For example, in the formula (G2), (OG^{f1}) and (OG^{f2}) may alternately be arranged, (OG^{f1}) and (OG^{f2}) may be arranged respectively in blocks, or may be randomly arranged.

In the formula (G2), m1 is preferably 1 to 30, more preferably 1 to 20. m2 is preferably 1 to 30, more preferably 1 to 20.

In the formula (G3), m2 is preferably 1 to 30, more preferably 1 to 20. m4 is preferably 1 to 30, more preferably 1 to 20.

In the formula (G4), m3 is preferably 1 to 30, more preferably 1 to 20.

In the fluoroether chain or the fluoropolyether chain (OR^{f11})_{y1}, the proportion of fluorine atoms [{number of fluorine atoms/(number of fluorine atoms+number of hydrogen atoms)}×100(%)] is, in view of excellent water/oil repellency and fingerprint removability, preferably 60% or more, more preferably 70% or more, further preferably 80% or more. The upper limit is for example 100%.

The molecular weight of the fluoroether chain or the fluoropolyether chain (OR^{f11})_{y1} moiety is, in view of abrasion resistance, preferably 2,000 to 20,000, more preferably 2,500 to 15,000, further preferably 3,000 to 10,000.

R¹ is an alkylene group or a fluoroalkylene group. The alkylene group and fluoroalkylene group as R¹ may be linear or may have a branch and/or a cyclic structure. In view of easiness of synthesis, etc., preferred is an alkylene group or a fluoroalkylene group that is linear or that has a branch, more preferred is an alkylene group or a fluoroalkylene group that is linear or that has a methylene group or a fluoromethylene group as a branch. The number of carbon atoms in R¹ is preferably 1 to 30, more preferably 1 to 20, further preferably 1 to 10.

j represents the number of [R^{f1}—(OR^{f11})_{y1}—O—R¹] in one molecule and is an integer of 1 or more, preferably 1 to 20, more preferably 1 to 10, further preferably 1 to 4.

R¹¹ is an alkylene group in which the atom bonded to L¹ may be an etheric oxygen atom, and which may have an etheric oxygen atom between carbon atoms.

The alkylene group as R¹¹ may be linear, or may have a branch and/or a cyclic structure. It is preferably an alkylene group that is linear or that has a branch, more preferably a linear alkylene group, whereby the Compound (A1) will densely be arranged when forming a surface layer.

The alkylene group as R¹¹ preferably has a carbon chain having 2 or more carbon atoms linked to each other, whereby the obtainable surface layer is more excellent in water/oil repellency and fingerprint removability and is also excellent in durability such as abrasion resistance.

The alkylene group as R¹¹ preferably has a carbon chain having three or more carbon atoms linked to one another, more preferably has a carbon chain having four or more carbon atoms linked to one another, particularly preferably has a carbon chain having 9 or more carbon atoms linked to one another, most preferably has a carbon chain having 11 or more carbon atoms linked to one another. By the alkylene group having a carbon chain having the above number of carbon atoms linked to one another, being adjacent to the hydrolysable silyl group, the obtainable surface layer has more improved abrasion resistance.

The upper limit of the number of carbon atoms is not particularly limited, and in view of more excellent water/oil repellency and fingerprint removability, the number of carbon atoms is preferably 20 or less, more preferably 19 or less.

Particularly, R¹¹ is preferably a C₃₋₂₀ linear alkylene group, more preferably a C₄₋₂₀ linear alkylene group, further preferably a C₉₋₂₀ linear alkylene group, particularly preferably a C₁₁₋₂₀ linear alkylene group.

“Having a carbon chain having X or more carbon atoms linked to one another” means that R¹¹ has an alkylene group having X or more carbon atoms. In the case of an alkylene group having a branch and/or a cyclic structure, carbon atoms in the branch and the cyclic structure are included. Specifically, for example, —CH₂CH₂CH(—CH₂CH₃)—CH₂CH₂CH₂CH₂— has a carbon chain having 9 carbon atoms linked including carbon atoms in the branch.

It is preferred that at least one R¹¹ has a carbon chain having four or more carbon atoms linked to one another, and the carbon chain is linked to T¹¹, and when there is a plurality of R¹¹, it is more preferred that all of the plurality of R¹¹ have a carbon chain having four or more carbon atoms linked to one another and each carbon chain is linked to T¹¹. The preferred embodiment of the number of carbon atoms linked in the carbon chain is as defined above.

R¹¹ is specifically represented by the following formula (g2).

*—(O)ₐ₁—(R^{g2}O)ₐ₂—R^{g2}—** (g2)
wherein R^{g2} is an alkylene group having 1 or more carbon atoms, and the plurality of R^{g2} if any may be the same or different from each other,
a1 is 0 or 1,
a2 is an integer of 0 or more,
* is a binding site bonded to L¹, and
** is a binding site bonded to T¹¹.

When a1 is 0, the atom having the binding site * is a carbon atom, and when a1 is 1, the atom having the binding site * is an oxygen atom. In the Compound (A1), a1 may be either 0 or 1 and is properly selected depending upon e.g. the synthesis.

a2 represents the number of repetition of R^{g2}O and in view of durability of the obtainable surface layer, is preferably 0 to 6, more preferably 0 to 3, further preferably 0 to 1.

The alkylene group as R^{g2} is the same as the alkylene group as R¹¹, and its preferred embodiment is also the same.

R¹¹ is further preferably a group represented by the following formula (g3), whereby the obtainable surface layer is more excellent in water/oil repellency and fingerprint removability and is also excellent in durability such as abrasion resistance.

*—(O)ₐ₁—R^{g3}—** (g3)
wherein R^{g3} is an alkylene group, and
a1, * and ** are as defined for the formula (g2).

The alkylene group as R^{g3} is the same as the alkylene group as R¹¹, and its preferred embodiment is also the same.

T¹¹ is a group represented by —SiR^{a11}_{z11}R^{a12}_{3-z11}.

R^{a11}, R^{a12} and z11 are each independently the same as R^{a11}, R^{a12} and z11 constituting T¹¹ in the above formula (A1), and their preferred embodiments are also the same.

x1 represents the number of R¹¹-T¹¹ in one molecule and is an integer of 1 or more, may be an integer of 2 or more, and is preferably an integer of 2 to 32, more preferably an integer of 2 to 18, further preferably an integer of 2 to 12.

L¹ is a single bond or a (j+x1)-valent group which may have N, O, S or Si and may have a branch point, and in which the atoms bonded to R¹ and R¹¹ are each independently N, O, S, Si, a carbon atom constituting the branch point, or a carbon atom having a hydroxy group or an oxo group (═O). The atom bonded to R¹ and the atom bonded to R¹¹ may be the same atom or may be different atoms.

In a case where L¹ is a single bond, R¹ and R¹¹ in the formula (A1) are directly bonded, and the Compound (A1) is represented by the following formula (A1′).

R^{f1}—(OR^{f11})_{y1}—O—R¹-R¹¹-T¹¹ (A1′)

Symbols in the formula (A1′) are as defined for the formula (A1).

In a case where L¹ is a trivalent or higher valent group, L¹ has at least one type of branch point (hereinafter referred to as “branch point P¹”) selected from the group consisting of C, N, Si, a cyclic structure and a (j+x1)-valent organopolysiloxane residue.

In a case where the branch point P¹ is N, the branch point P¹ is represented, for example, by *—N(—**)₂ or (*—)₂N—**. * is a binding site on the R¹ side, and ** is a binding site on the R¹¹ side.

In a case where the branch point P¹ is C, the branch point P¹ is represented, for example, by *—C(**)₃, (*—)₂C(—*)₂, (*—)₃C—**, *—CR²⁹(—**)₂, or (*—)₂CR²⁹—**. * is a binding site on the R¹ side, ** is a binding site on the R¹¹ side, and R²⁹ is a monovalent group and may, for example, be a hydrogen atom, a hydroxy group, a hydrocarbon group, or an alkoxy group. The hydrocarbon group may be an aliphatic hydrocarbon group such as a linear alkyl group, an alkyl group having a branch or a cycloalkyl group, an aromatic hydrocarbon group such as a phenyl group, or a combination thereof.

In a case where the branch point P¹ is Si, the branch point P¹ is represented, for example, by *—Si(—*)₃, (*—)₂Si(—*)₂, (*—)₃Si—**, *—SiR²⁹(—**)₂, or (*—)₂SiR²⁹—**. * is a binding site on the R¹ side, ** is a binding site on the R¹¹ side, and R²⁹ is a monovalent group and may, for example, be a hydrogen atom, a hydroxy group, a hydrocarbon group, or an alkoxy group. The hydrocarbon group may be an aliphatic hydrocarbon group such as a linear alkyl group, an alkyl group having a branch or a cycloalkyl group, an aromatic hydrocarbon group such as a phenyl group, or a combination thereof.

The cyclic structure constating the branch point P¹ is preferably at least one member selected from the group consisting of a 3- to 8-membered aliphatic ring, a 3- to 8-membered aromatic ring, a 3- to 8-membered heterocyclic ring and a condensed ring of 2 or more of such rings, more preferably a cyclic structure of any of the following formulae, in view of easiness of production of the Compound (A1) and whereby the obtainable surface layer will be more excellent in abrasion resistance, light resistance and chemical resistance. The cyclic structure may have a substituent such as a halogen atom, an alkyl group (which may have an etheric oxygen atom between carbon atoms), a cycloalkyl group, an alkenyl group, an allyl group, an alkoxy group or an oxo group (═O).

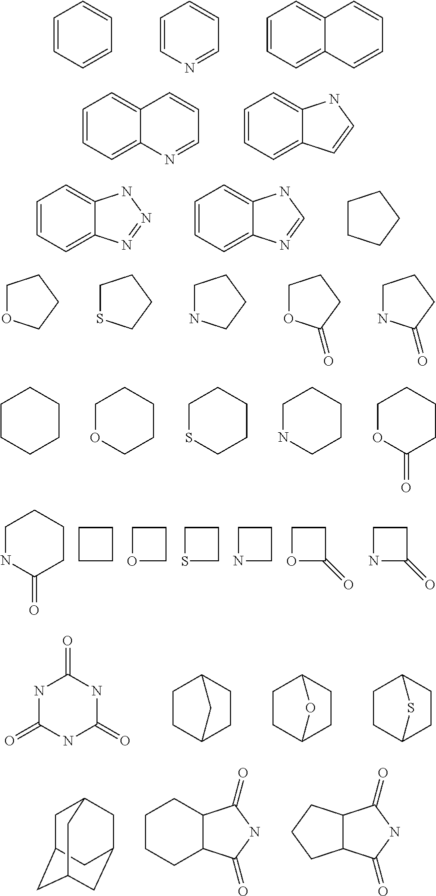

As the organopolysiloxane residue constituting the branch point P¹, the following groups may be mentioned. In the following formulae, R²⁵ is a hydrogen atom, an alkyl group, an alkoxy group or a phenyl group. The number of carbon atoms in the alkyl group or the alkoxy group as R²⁵ is preferably 1 to 10, more preferably 1. The plurality of R²⁵ may be the same or different from each other.

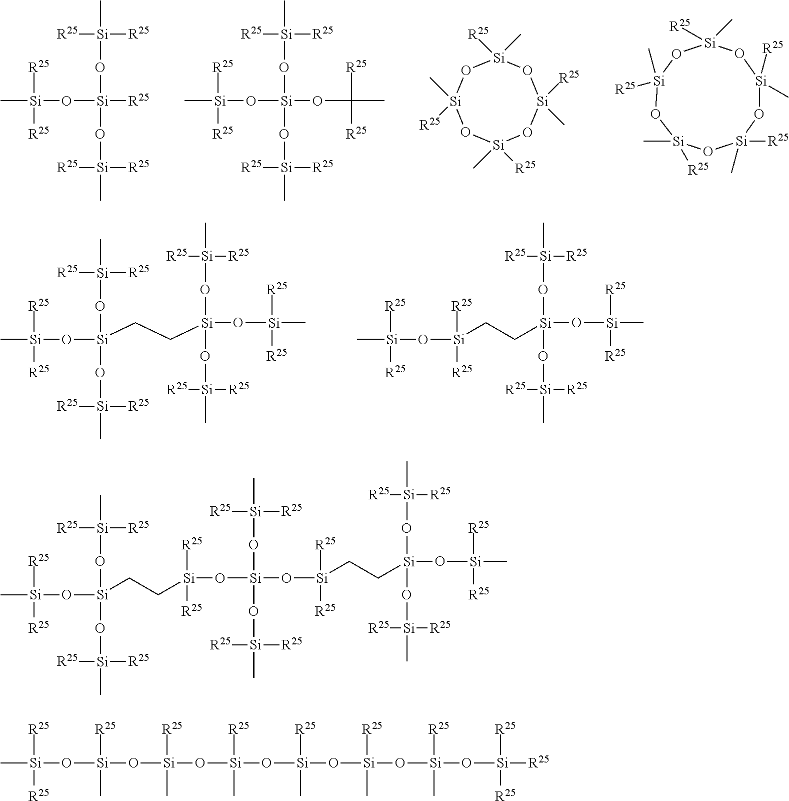

Bivalent or higher valent L¹ may have at least one bond selected from the group consisting of —C(O)N(R²⁶)—, —N(R²⁶)C(O)—, —C(O)O—, —OC(O)—, —C(O)—, —C(OH)—, —O—, —N(R²⁶)—, —S—, —OC(O)O—, —NHC(O)O—, —OC(O)NH—, —NHC(O)N(R²⁶)—, —SO₂N(R²⁶)—, —N(R²⁶)SO₂—, —Si(R²⁶)₂—, —OSi(R²⁶)₂—, —Si(CH₃)₂-Ph-Si(CH₃)₂— and a bivalent organopolysiloxane residue (hereinafter sometimes referred to as “bond B¹”).

In the above formulae, R²⁶ is a hydrogen atom, a C₁₋₆ alkyl group or a phenyl group, and Ph is a phenylene group. The number of carbon atoms in the alkyl group as R²⁶ is, in view of easiness of production of the Compound (A1), preferably 1 to 6, more preferably 1 to 3, further preferably 1 to 2.

As the bivalent organopolysiloxane residue, the following groups may, for example, be mentioned. In the following formulae, R²⁷ is a hydrogen atom, an alkyl group, an alkoxy group or a phenyl group. The number of carbon atoms in the alkyl group or the alkoxy group as R²⁷ is preferably 1 to 10, more preferably 1. The plurality of R²⁷ may be the same or different from each other.

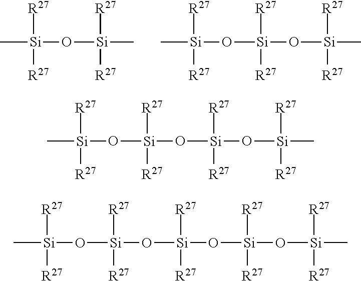

The bond B¹ is, in view of easiness of production of the Compound (A1), preferably at least one bond selected from the group consisting of —C(O)NR²⁶—, —N(R²⁶)C(O)—, —C(O)—, and —NR²⁶—, more preferably —C(O)NR²⁶—, —N(R²⁶)C(O)— or —C(O)—, whereby the obtainable surface layer will be more excellent in light resistance and chemical resistance.

In bivalent L¹, the atoms bonded to R¹ and R¹¹ are each independently N, O, S, Si, or a carbon atom having a hydroxy group or an oxo group (═O). That is, the atoms adjacent to R¹ and R¹¹ are respectively elements constituting the bond B¹. Specific examples of the bivalent L¹ include 1 or more of the bonds B¹ (for example *-B¹-**, *-B¹-R²⁸-B¹-**). R²⁸ is a single bond or a bivalent organic group, * is a binding site on the R¹ side, and ** is a binding site on the R¹¹ side.

In trivalent or higher valent L¹, the atoms bonded to R¹ and R¹¹ are each independently N, O, S, Si, a carbon atom constituting the branch point, or a carbon atom having a hydroxy group or an oxo group (═O). That is, the atoms adjacent to R¹ and R¹¹ are respectively elements constituting the bond B¹ or the branch point P¹. Specific examples of the trivalent or higher valent L¹ include 1 or more of the branch points P¹ (for example {(*-)ⱼP¹(-**)ₓ₁}, {(*-)ⱼP¹-R²⁸-P¹(-**)ₓ₁}), a combination of 1 or more of the branch points P¹ and 1 or more of the bonds B¹ (for example {*-B¹-R²⁸-P¹(-**)ₓ₁}, {*-B¹-R²⁸-P¹(-R²⁸-B¹-**)ₓ₁}). R²⁸ is a single bond or a bivalent organic group, * is a binding site on the R¹ side, and ** is a binding site on the R¹¹ side.

The bivalent organic group as R²⁸ may be a hydrocarbon group such as a bivalent aliphatic hydrocarbon group (e.g. an alkylene group or a cycloalkylene group), a bivalent aromatic hydrocarbon group (e.g. a phenylene group), and may have the bond B¹ between carbon atoms in the hydrocarbon group. The number of carbon atoms in the bivalent organic group is preferably 1 to 10, more preferably 1 to 6, further preferably 1 to 4.

The above L¹ is, in view of easiness of production of the Compound (A1), preferably a group represented by any one of the following formulae (L¹) to (L⁷).

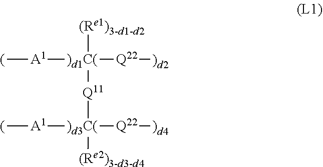

(-A¹-)_{d5}C(R^{e2})_{4-d5-d6}(-Q²²-)_{d6} (L2)

(-A²-)_{d7}N(-Q²³-)_{3-d7} (L3)

(-A³-)_{d8}Z¹(-Q²⁴-)_{d9} (L4)

(-A²-)_{d10}Si(R^{e3})_{4-d10-d11}(-Q²⁵-)_{d11} (L5)

-A¹-Q²⁶- (L6)

-A¹-CH(-Q²²-)-Si(R^{e3})_{3-d12}(-Q²⁵-)_{d12} (L7)

The group of each of the formulae (L1) to (L7) is linked to R¹ of the formula (A1) on the A¹, A² or A³ side, and is linked to R¹¹ on the Q²², Q²³, Q²⁴, Q²⁵ or Q²⁶ side.
A¹ is a single bond, -B³-, -B³-R³⁰—, or, -B³-R³⁰-B²-, wherein R³⁰ is an alkylene group or a group having —C(O)NR^{e6}—, —C(O)—, —NR^{e6}— or —O— between carbon atoms of an alkylene group having 2 or more carbon atoms, B² is —C(O)NR^{e6}—, —C(O)—, —NR^{e6}— or —O—, and B³ is —C(O)NR^{e6}—, —C(O)—, or —NR^{e6}—,
A² is a single bond or -B³-R³⁰—,
A³ is A¹ in a case where the atom in Z¹ to which A³ is bonded is a carbon atom, and is A² in a case where the atom in Z¹ to which A³ is bonded is a nitrogen atom,
Q¹¹ is a single bond, —O—, an alkylene group, or a group having —C(O)NR^{e6}—, —C(O)—, —NR^{e6}— or —O— between carbon atoms in an alkylene group having 2 or more carbon atoms,
Q²² is a single bond, -B³-, —R³⁰-B³- or -B²-R³⁰-B³
Q²³ is a single bond or —R³⁰-B³-,
Q²⁴ is Q²² in a case where the atom in Z¹ to which Q²⁴ is bonded is a carbon atom, and is Q²³ in a case where the atom in Z¹ to which Q²⁴ is bonded is a nitrogen atom,
Q²⁵ is a single bond or —R³⁰-B³-,
Q²⁶ is a single bond or —R³⁰-B³-,
Z¹ is a (d8+d9)-valent group having a cyclic structure, having a carbon atom or a nitrogen atom to which A³ is directly bonded and having a carbon atom or a nitrogen atom to which Q²⁴ is directly bonded,
R^{e1} is a hydrogen atom or a hydrocarbon group (e.g. an alkyl group or an aromatic hydrocarbon group such as a phenyl group),
R^{e2} is a hydrogen atom, a hydroxy group, a hydrocarbon group (e.g. an alkyl group or an aromatic hydrocarbon group such as a phenyl group) or an acyloxy group,
R^{e3} is a hydrocarbon group (e.g. an alkyl group or an aromatic hydrocarbon group such as a phenyl group),
R^{e6} is a hydrogen atom, a C₁₋₆ alkyl group or a phenyl group,
d1 is an integer of 0 to 3, d2 is an integer of 0 to 3, and d1+d2 is an integer of 1 to 3,
d3 is an integer of 0 to 3, d4 is an integer of 0 to 3, and d3+d4 is an integer of 1 to 3,
d1+d3 is an integer of 1 to 5,
d2+d4 is an integer of 2 to 5,
d5 is an integer of 1 to 3, d6 is an integer of 2 to 3, and d5+d6 is an integer of 3 to 4,
d7 is 1,
d8 is an integer of 1 or more,
d9 is an integer of 2 or more,
d10 is an integer of 1 to 3, d11 is an integer of 2 to 3, and d10+d11 is an integer of 3 to 4, and
d12 is an integer of 1 to 3.

The directions of B² and B³ are not limited. When there is a plurality of A¹, the plurality of A¹ may be the same or different from each other. The same applies to A², A³, Q²², Q²³, Q²⁴, Q²⁵, Q²⁶, R^{e1}, R^{e2}, and R^{e3}.

Further, d1+d3, d5, d7, d8, d10 are j, and d2+d4, d6, 3-d7, d9, d11, and 1+d12 are x1.

The number of carbon atoms in the alkylene group as R³⁰ is preferably 1 to 10, more preferably 1 to 6, further preferably 1 to 4, in view of easiness of production of the Compound (A1), and whereby the obtainable surface layer will be more excellent in abrasion resistance, light resistance and chemical resistance. In a case where the alkylene group has a specific bond between carbon atoms, the lower limit of the number of carbon atoms in such an alkylene group is 2.

The cyclic structure in Z¹ may be the above described cyclic structure, and its preferred embodiment is also the same.

The number of carbon atoms in the alkyl group as R^{e1}, R^{e2} or R^{e3} is, in view of easiness of production of the Compound (A1), preferably 1 to 6, more preferably 1 to 3, further preferably 1 to 2.

The number of carbon atoms in the alkyl group moiety of the acyloxy group as R^{e2} is, in view of easiness of production of the Compound 1, preferably 1 to 6, more preferably 1 to 3, further preferably 1 to 2.

d9 is preferably 2 to 6, more preferably 2 to 4, further preferably 2 or 3, in view of easiness of production of the Compound (A1), and whereby the obtainable surface layer will be more excellent in abrasion resistance and fingerprint removability.

As other embodiments of L¹, groups represented by the following formulae (L11) to (L¹⁷) may be mentioned.

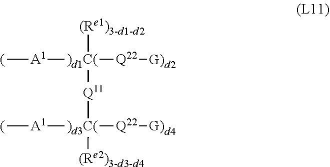

(-A¹-)_{d5}C(R^{e2})_{4-d5-d6}(-Q²²-G)_{d6} (L12)

(-A²-)_{d7}N(-Q²³-G)_{3-d7} (L13)

(-A³-)_{d8}Z¹(-Q²⁴-G)_{d9} (L14)

(-A²-)_{d10}Si(R^{e3})_{4-d10-d11}(-Q²⁵-G)_{d11} (L15)

-A¹-Q²⁶-G (L16)

-A¹-CH(-Q²²-G)-Si(R^{e3})_{3-d12}(-Q²⁵-G)_{d12} (L17)

The group of each of the formulae (L11) to (L17) is linked to R¹ of the formula (A1) on the A¹, A² or A³ side, and is linked to R¹¹ on the Q²², Q²³, Q²⁴, Q²⁵ or Q²⁶ side. G is the following group (G21), and 2 or more G which L¹ has may be the same or different from each other. Symbols other than G are the same as the symbols in the formulae (L1) to (L7).

—Si(R⁵¹)₃₋ₖ(-Q³-)ₖ (G21)

The above group of the formula (G21) is linked to Q²², Q²³, Q²⁴, Q²⁵ or Q²⁶ on the Si side, and is linked to R¹¹ on the Q³ side. R⁵¹ is an alkyl group. Q³ is a single bond, or —R³¹-B³-, R³¹ is an alkylene group, a group having —C(O)NR³²—, —C(O)—, —NR³²— or —O— between carbon atoms in an alkylene group having 2 or more carbon atoms, or —(OSi(R²²)₂)ₚ₁₁—O—, and 2 or more Q³ may be the same or different from each other. k is 2 or 3. R³² is a hydrogen atom, a C₁₋₆ alkyl group or a phenyl group. R²² is an alkyl group, a phenyl group or an alkoxy group, and the two R²² may be the same or different from each other. p11 is an integer of 0 to 5, and when p11 is 2 or more, the 2 or more (OSi(R²²)₂) may be the same or different from each other.

In a case where Q³ is —R³¹-B³-, the number of carbon atoms in the alkylene group as R³¹ is preferably 1 to 10, more preferably 1 to 6, further preferably 1 to 4, in view of easiness of production of the Compound (A1), and whereby the obtainable surface layer will be more excellent in abrasion resistance, light resistance and chemical resistance. In a case where the alkylene group has a specific bond between carbon atoms, the lower limit of the number of carbon atoms in such an alkylene group is 2.

The number of carbon atoms in the alkyl group as R⁵¹ is, in view of easiness of production of the Compound (A1), preferably 1 to 6, more preferably 1 to 3, further preferably 1 to 2.

The number of carbon atoms in the alkyl group as R²² is, in view of easiness of production of the Compound (A1), preferably 1 to 6, more preferably 1 to 3, further preferably 1 to 2.

The number of carbon atoms in the alkoxy group as R²² is, in view of excellent storage stability of the Compound (A1), preferably 1 to 6, more preferably 1 to 3, further preferably 1 to 2.

p11 is preferably 0 or 1.

The molecular weight of the group represented by L¹-(R¹¹-T¹¹)ₓ₁ is preferably 300 or more, more preferably 450 or more, further preferably 600 or more, whereby the obtainable surface layer will have more improved abrasion resistance.

On the other hand, the molecular weight is preferably 2,000 or less, more preferably 1,500 or less, further preferably 1,000 or less, in view of more excellent antifouling property.

The ratio of the molecular weight of the fluoropolyether chain represented by [R^{f1}—(OR^{f11})_{y1}—O—R¹]; to the molecular weight of the group represented by L¹-(R¹¹-T¹¹)ₓ₁, is preferably 10% or more, more preferably 12% or more, further preferably 13% or more, whereby the obtainable surface layer will have more improved abrasion resistance.

The upper limit of the above ratio is preferably 40% or less, more preferably 25% or less, in view of more excellent antifouling property.

As the Compound (A1), the following may, for example, be mentioned.

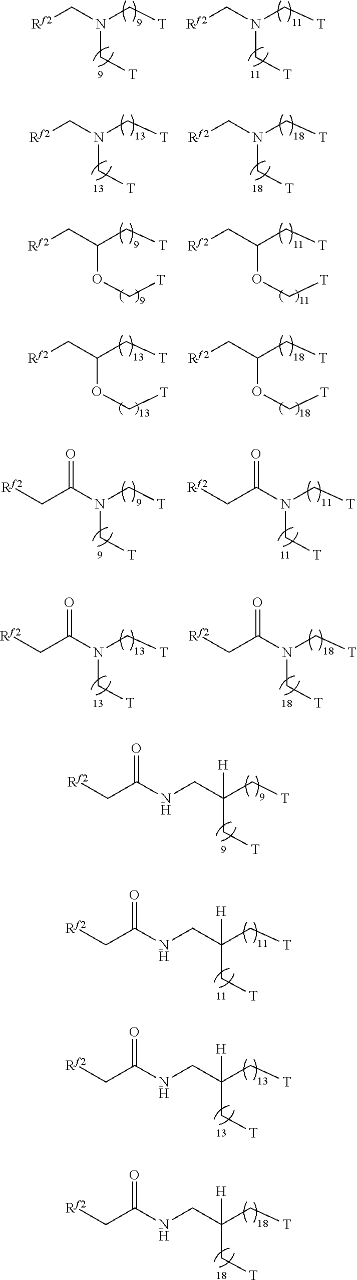

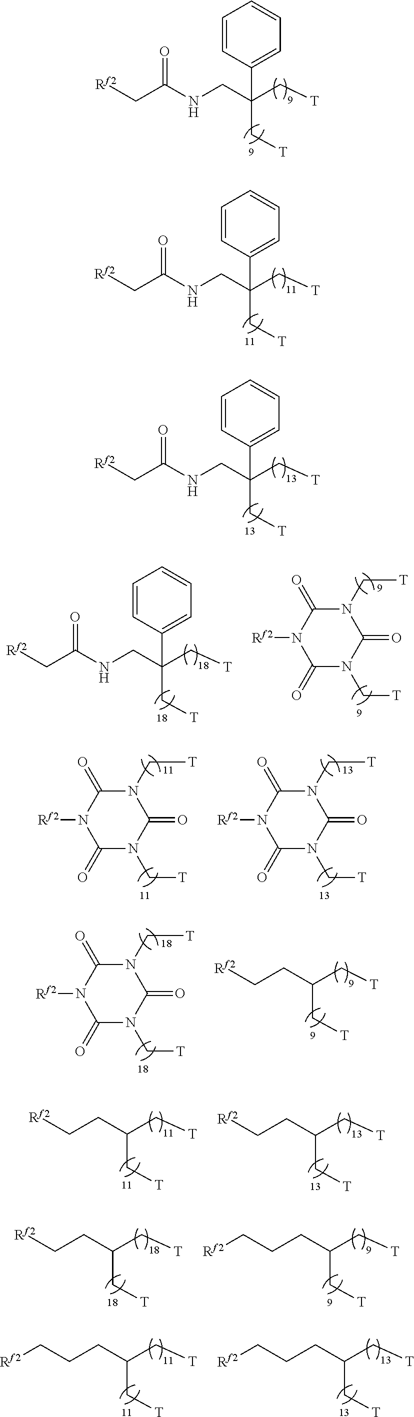

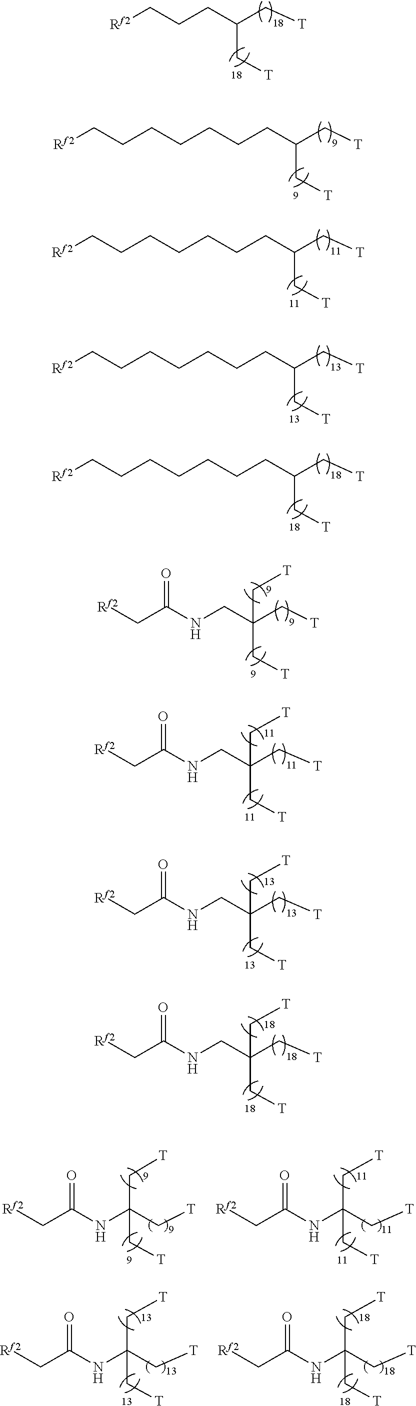

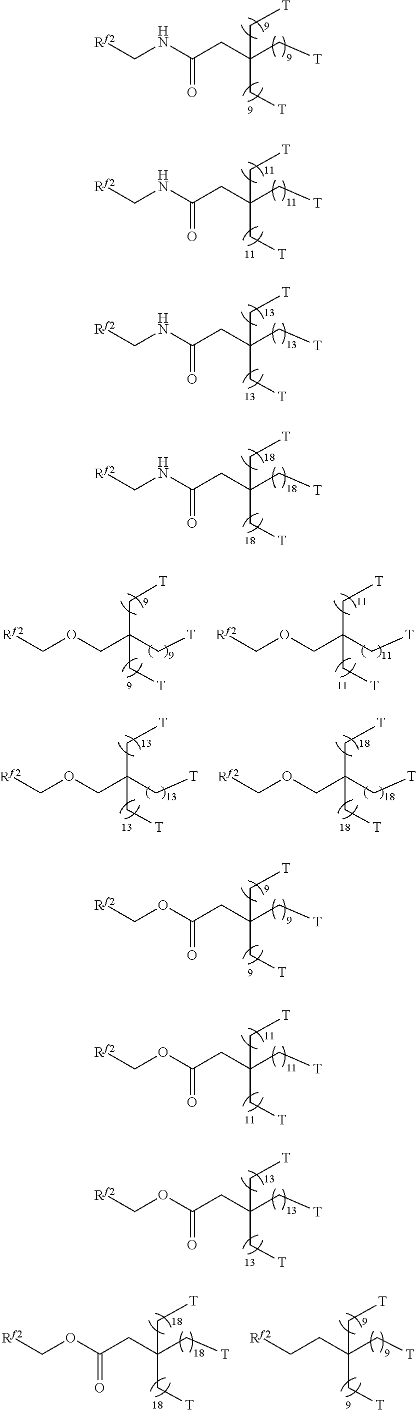

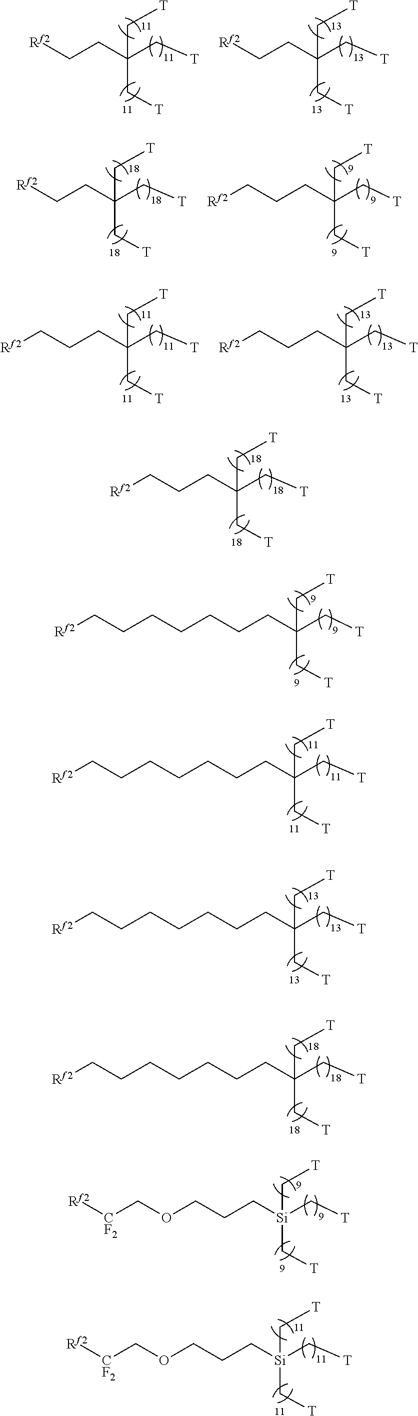

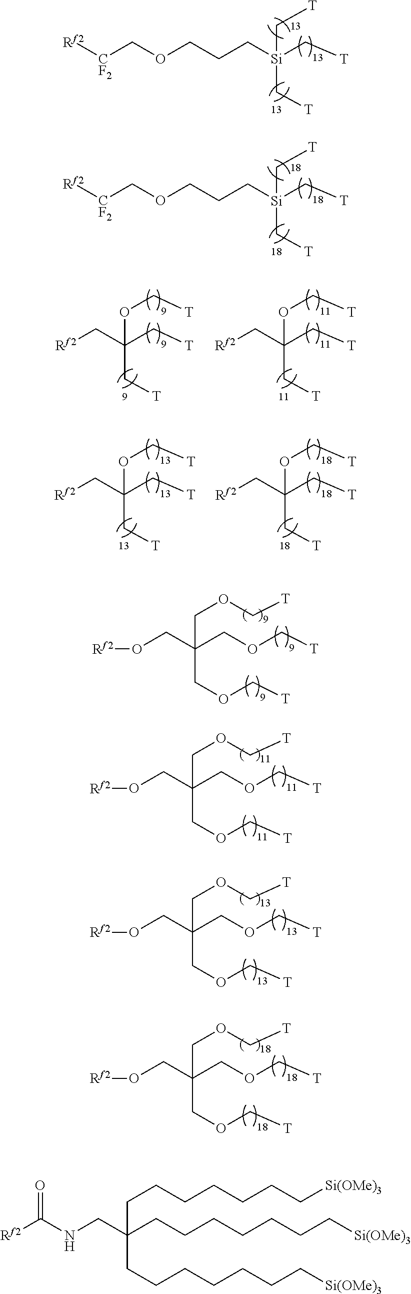

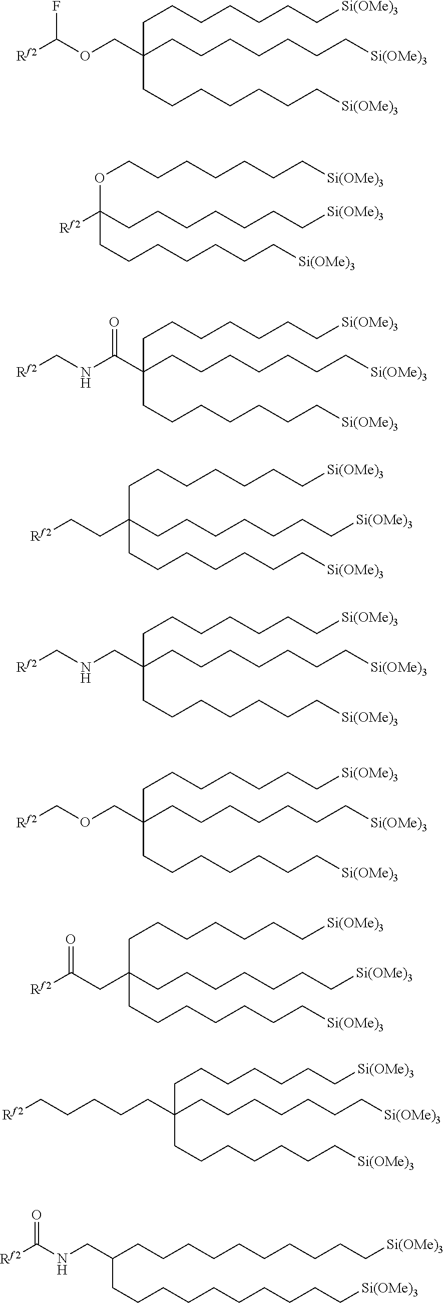

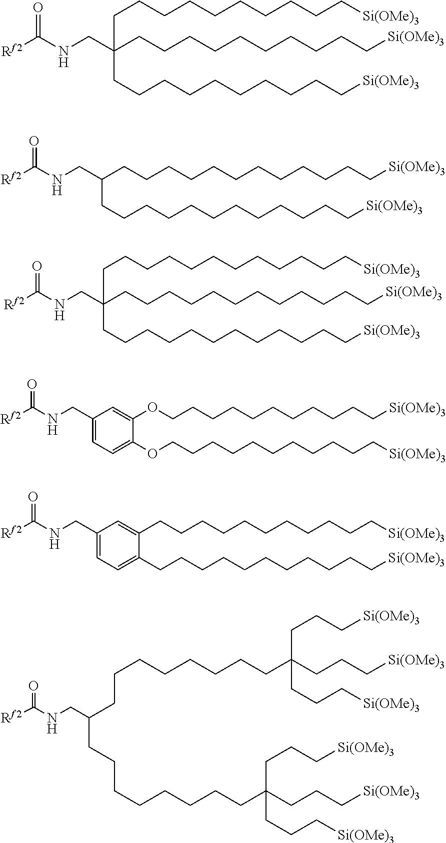

R^{f2} is each independently the same as [R^{f1}—(OR^{f11})_{y1}—O—R¹] or [R^{f1}—(OR^{f11})_{y1}—O—], T is the same as T¹¹, and Me represents a methyl group.

### (Compound (A2))

The Compound (A2) has a structure represented by the following formula (A2).

(T³¹-R³¹)ₓ₃-L³-R³—(OR^{f12})_{y2}—O—R²-L²-(R²¹-T²¹)ₓ₂ (A2)

Symbols in the formula (A2) are as defined above.

R^{f12} and (OR^{f12})_{y2} are the same as the above R^{f11} and (OR^{f11})_{y1}, and their preferred embodiments are also the same.

R² and R³ are each independently the same as R¹, and their preferred embodiments are also the same.

R²¹ and R³¹ are the same as R¹¹, and their preferred embodiments are also the same. “Bonded to L¹” is read as “bonded to L²” in the case of R²¹, and is read as “bonded to L³” in the case of R³¹. “Bonded to T¹¹” is read as “bonded to T²¹” in the case of R²¹, and is read as “bonded to T³¹” in the case of R³¹.

As a specific example of the preferred embodiments of R²¹ and R³¹, either at least one R²¹ has a carbon chain having four or more carbon atoms linked to one another and the carbon chain is linked to T²¹, or at least one R³¹ has a carbon chain having four or more carbon atoms linked to one another and the carbon chain is linked to T³¹. When there is a plurality of R²¹, it is more preferred that all of the plurality of R²¹ have a carbon chain having four or more carbon atoms linked to one another and the carbon chain is linked to T²¹. When there is a plurality of R³¹, it is more preferred that all of the plurality of R³¹ have a carbon chain having four or more carbon atoms linked to one another and the carbon chain is linked to T³¹. The preferred embodiment of the number of carbon atoms linked in the carbon chain is as the same as R¹¹.

T²¹ and T³¹ are each independently —SiR^{a21}_{z21}R^{a22}_{3-z21}, R^{a21}, R^{a22} and z21 are each independently the same as R^{a11}, R^{a12} and z11 constituting T¹¹, and their preferred embodiments are also the same.

x2 and x3 are each independently the same as x1, and their preferred embodiments are also the same.

L² and L³ are each independently the same as L¹ wherein j is 1.

For example in a case where L² and L³ are a single bond, the Compound (A2) is represented by the following formula (A2′).

T³¹-R³¹-R³—(OR^{f12})_{y2}—O—R²-R²¹-T²¹ (A2′)

Symbols in the formula (A2′) are as defined for the formula (A2).

In a case where L² or L³ is a trivalent or higher valent group, the trivalent or higher valent L² or L³ has at least one type of branch point (hereinafter referred to as “branch point P²”) selected from the group consisting of C, N, Si, a cyclic structure and a (1+x2)-valent or (1+x3)-valent organopolysiloxane residue.

In a case where the branch point P² is N, the branch point P² is represented, for example, by *—N(*)₂. * is a binding site on the R² or R³ side, and ** is a binding site on the R²¹ or R³¹ side.

In a case where the branch point P² is C, the branch point P² is represented, for example, by *—C(—*)₃, or *—CR²⁹(—*)₂. * is a binding site on the R² or R³ side, * is a binding site on the R²¹ or R³¹ side, and R²⁹ is a monovalent group. R²⁹ may be a hydrogen atom, a hydroxy group, an alkyl group, or an alkoxy group.

In a case where the branch point P² is Si, the branch point P² is represented, for example, by *—Si(—**)₃, or *—SiR²⁹(—**)₂.

* is a binding site on the R² or R³ side, ** is a binding site on the R²¹ or R³¹ side, and R²⁹ is a monovalent group. R²⁹ may be a hydrogen atom, a hydroxy group, an alkyl group, or an alkoxy group.

The cyclic structure and the organopolysiloxane residue constituting the branch point P² are the same as for the branch point P¹, and their preferred embodiments are also the same.

The bivalent or higher valent L² and L³ may each independently have the bond B¹. The embodiment of the bond B¹ is as defined above, and its preferred embodiment is also the same.

In the bivalent L² or L³, the atoms bonded to R² and R²¹, or R³ and R³¹, are each independently N, O, S, Si, or a carbon atom having a hydroxy group or an oxo group (═O). That is, the atoms adjacent to R² and R²¹, or R³ and R³¹, are respectively elements constating the bond B¹. Specific examples of the bivalent L² or L³ include 1 or more of the bonds B¹ (for example *-B¹-**, *-B¹-R²⁸-B¹-**). R²⁸ is a single bond or a bivalent organic group, * is a binding site on the R² or R³ side, and ** is a binding site on the R²¹ or R³¹ side.

In the trivalent or higher L² or L³, the atoms bonded to R² and R²¹, or R³ and R³¹, are each independently N, O, S, Si, a carbon atom constituting the branch point, or a carbon atom having a hydroxy group or an oxo group (═O). That is, the atoms adjacent to R² and R²¹, or R² and R³¹, are respectively elements constituting the bond B¹ or the branch point P². Specific examples of the trivalent or higher valent L² or L³ include 1 or more of the branch points P² (for example {*-P²(-**)ₓ}, {*-P²-R²⁸-P²-**ₓ}), and a combination of 1 or more of the branch points P² and 1 or more of the bonds B¹ (for example {*-B¹-R²⁸-P²(-**)ₓ}, {*-B²-R²⁸-P²(-R²⁸-B¹-**)ₓ}). x is x2 in the case of L², and is x3 in the case of L³. R²⁸ is a single bond or a bivalent organic group, * is a binding site on the R² or R³ side, and ** is a binding site on the R²¹ or R³¹ side.

The embodiment of the above R²⁸ is as described above, and its preferred embodiment is also the same.

L² or L³ are, in view of easiness of production of the Compound (A2), each independently preferably any one of groups represented by the following formulae (L21) to (L²⁷).

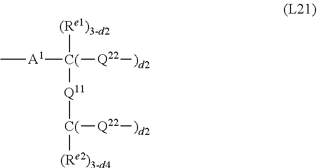

-A¹-C(R^{e2})_{4-d6}(-Q²²-)_{d6} (L22)

-A²-N(-Q²³-)₂ (L23)

-A³-Z¹(-Q²⁴-)_{d9} (L24)

-A²-Si(R^{e3})_{4-d11}(-Q²⁵-)_{d11} (L25)

-A¹-Q²⁶- (L26)

-A¹-CH(-Q²²-)-Si(R^{e3})_{3-d12}(-Q²⁵-)_{d12} (L27)

The group of each of the formulae (L21) to (L27) is linked to R² or R³ on the A¹, A² or A³ side, and is linked to R²¹ or R³¹ on the Q²², Q²³, Q²⁴, Q²⁵ or Q²⁶ side.

A¹, A², A³, Q¹¹, Q²², Q²³, Q²⁴, Q²⁵, Q²⁶, R^{e1}, R^{e2} and R^{e3} are as defined for L¹, and their preferred embodiments are also the same.
Z¹ is a (1+d9)-valent group having a cyclic structure, having a carbon atom or a nitrogen atom to which A³ is directly bonded and having a carbon atom or a nitrogen atom to which Q²⁴ is directly bonded,
d2 is an integer of 0 to 3, d4 is an integer of 0 to 3, and d2+d4 is an integer of 2 to 5,
d6 is an integer of 2 to 3,
d9 is an integer of 2 or more,
d11 is an integer of 2 to 3, and
d12 is an integer of 1 to 3.
d2+d4, d6, d9, d11, and 1+d12 are x2 or x3.
d9 is preferably 2 to 6, more preferably 2 to 4, further preferably 2 or 3, in view of easiness of production of the Compound (A2) and whereby the obtainable surface layer will be more excellent in abrasion resistance and fingerprint removability.

As other embodiments of L² and L³, groups represented by the following formulae (L31) to (L37) may be mentioned.

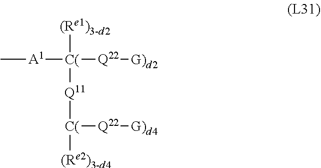

-A¹-C(R^{e2})_{4-d6}(-Q²²-G)_{d6} (L32)

-A²-N(-Q²³-G)₂ (L33)

-A³-Z¹(-Q²⁴-G)_{d9} (L34)

-A²-Si(R^{e3})_{4-d11}(-Q²⁵-G)_{d11} (L35)

-A¹-Q²⁶-G (L36)

-A¹-CH(-Q²²-G)-Si(R^{e3})_{3-d12}(-Q²⁵-G)_{d12} (L37)

The group of each of the formulae (L31) to (L37) is bonded to R² or R³ on the A¹, A² or A³ side, and is bonded to R²¹ or R³¹ on the Q²², Q²³, Q²⁴, Q²⁵ or Q²⁶ side. G is the above group (G21), and its preferred embodiment is also the same. Symbols other than G are the same as the symbols in the formulae (L21) to (L27), and their preferred embodiments are also the same.

In the Compound (A2), the molecular weight of at least one of the group represented by L²-(R²¹-T²¹)ₓ₂ and the group represented by (T³¹-R³¹)ₓ₃-L³ is preferably 300 or more, more preferably 450 or more, further preferably 600 or more, whereby the obtainable surface layer will have more improved abrasion resistance.

On the other hand, the above molecular weight is preferably 2,000 or less, more preferably 1,500 or less, further preferably 1,000 or less, in view of more excellent antifouling property.

It is preferred that both the molecular weight of the group represented by L²-(R²¹-T²¹)ₓ₂ and the molecular weight of the group represented by (T³¹-R³¹)ₓ₃-L³ are within the above range.

The ratio of the molecular weight of the group represented by R³—(OR^{f12})_{y2}—O—R² to the sum of the molecular weight of the group represented by L²-(R²¹-T²¹)ₓ₂ and the molecular weight of the group represented by (T³¹-R³¹)ₓ₃-L³, is preferably 10% or more, more preferably 12% or more, further preferably 13% or more, whereby the obtainable surface layer will have more improved abrasion resistance.

The upper limit of the above ratio is, in view of more excellent antifouling property, preferably 40% or less, more preferably 25% or less.

As the Compound (A2), the following may, for example, be mentioned.

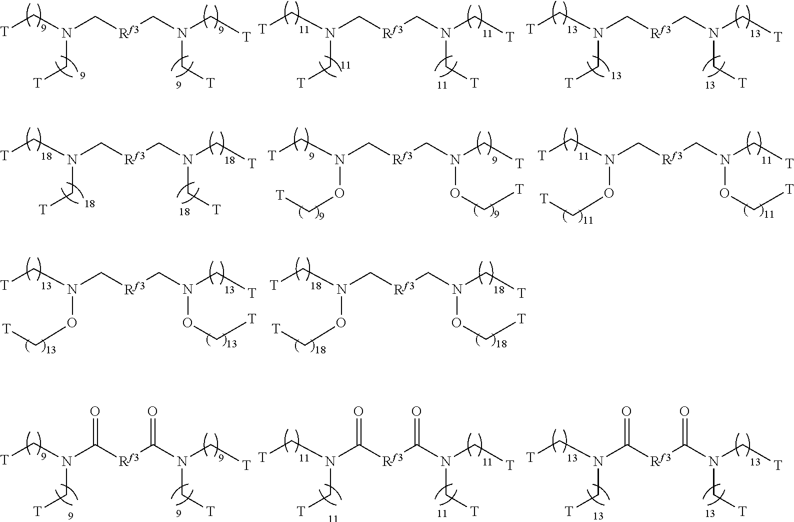

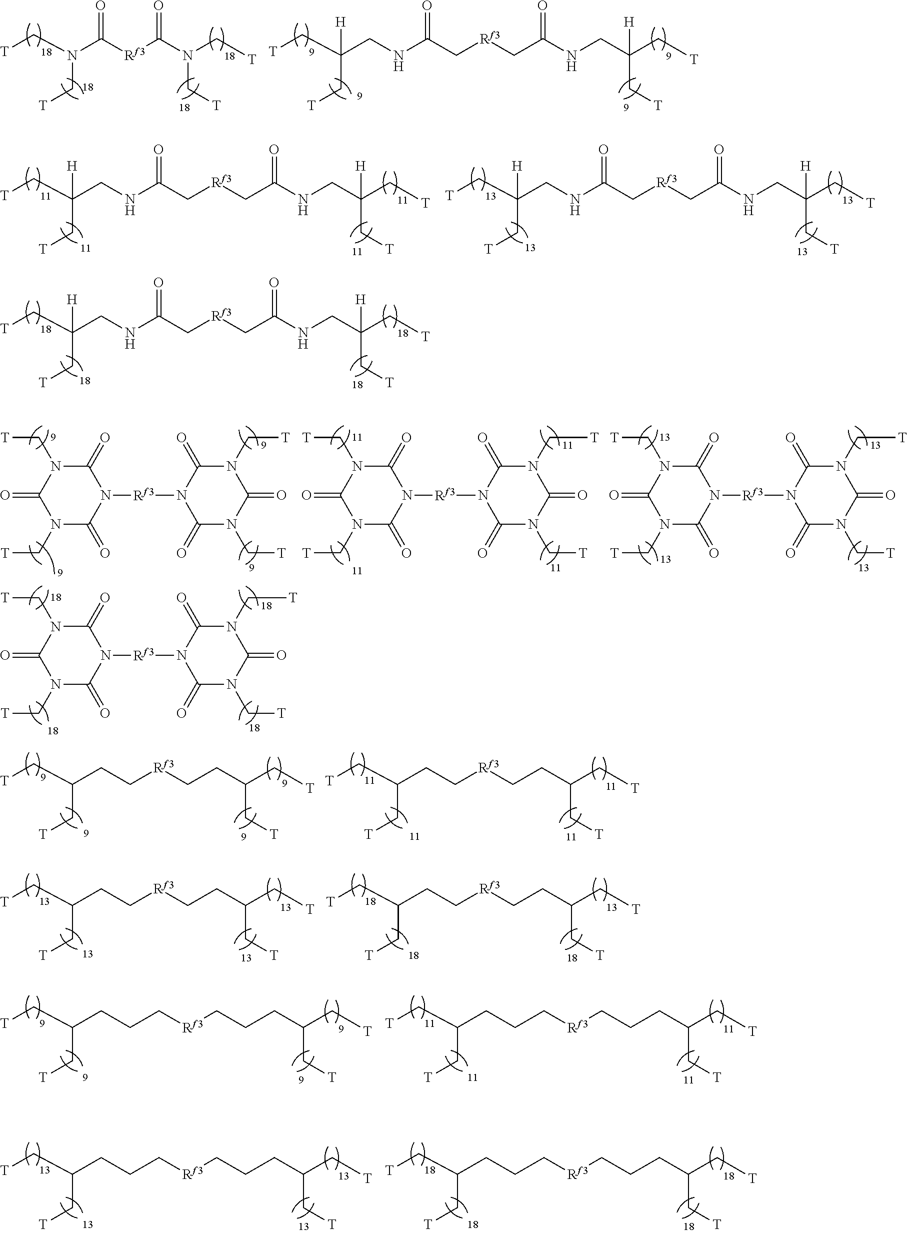

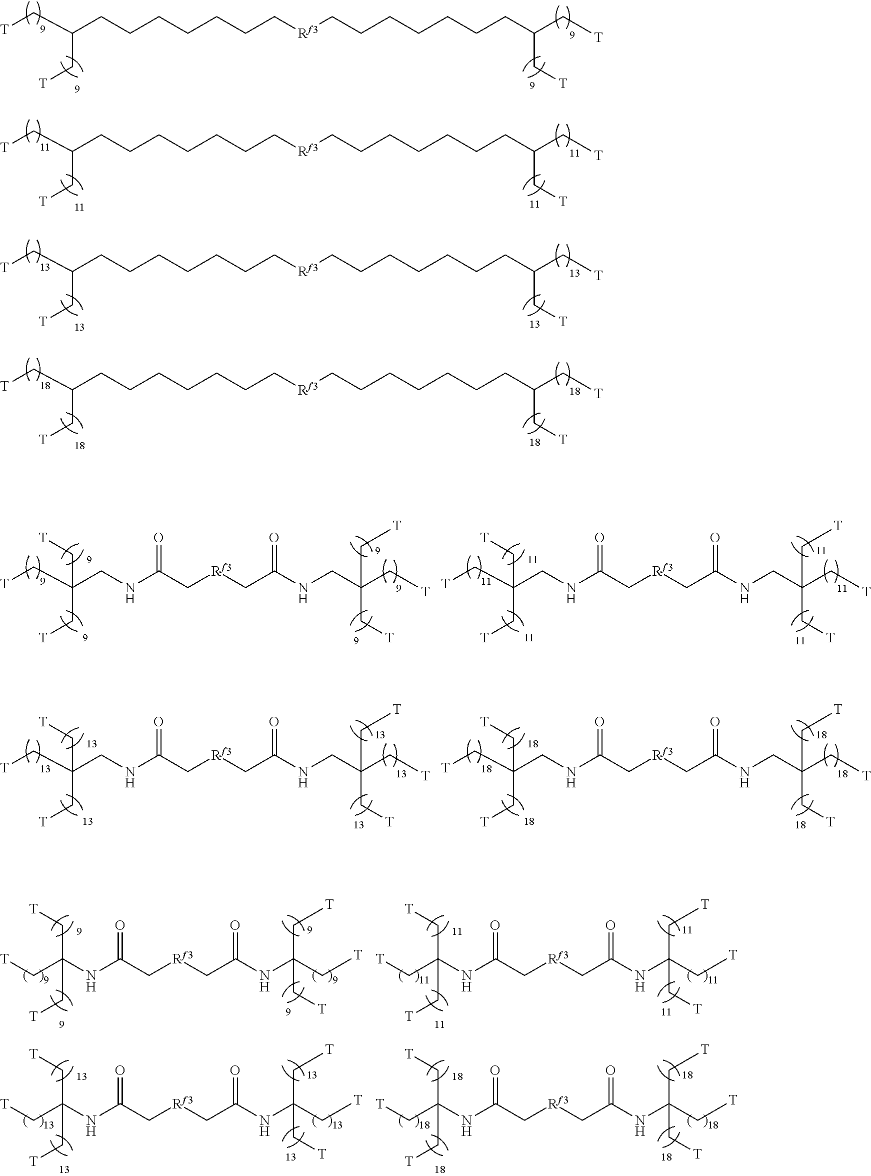

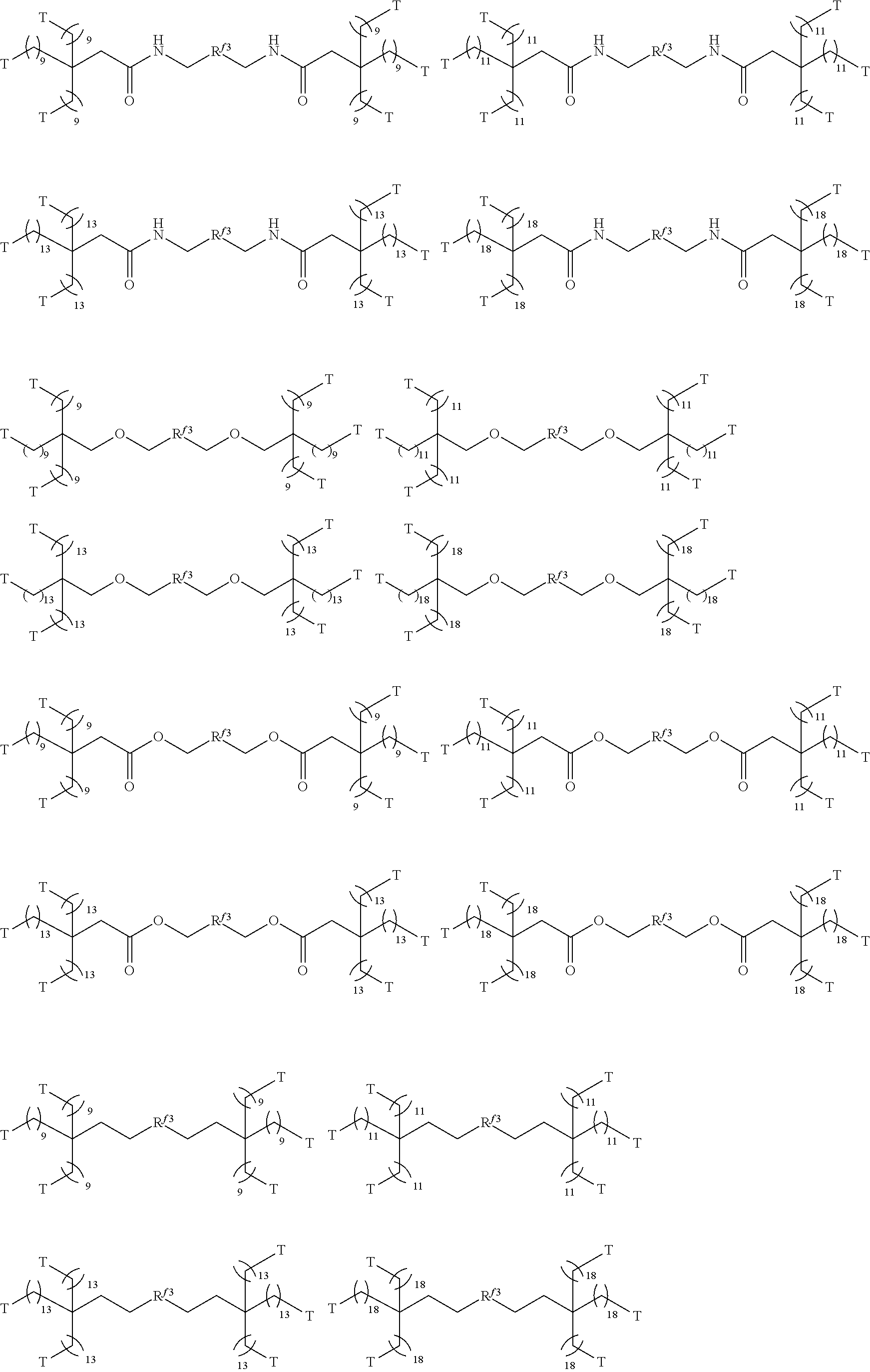

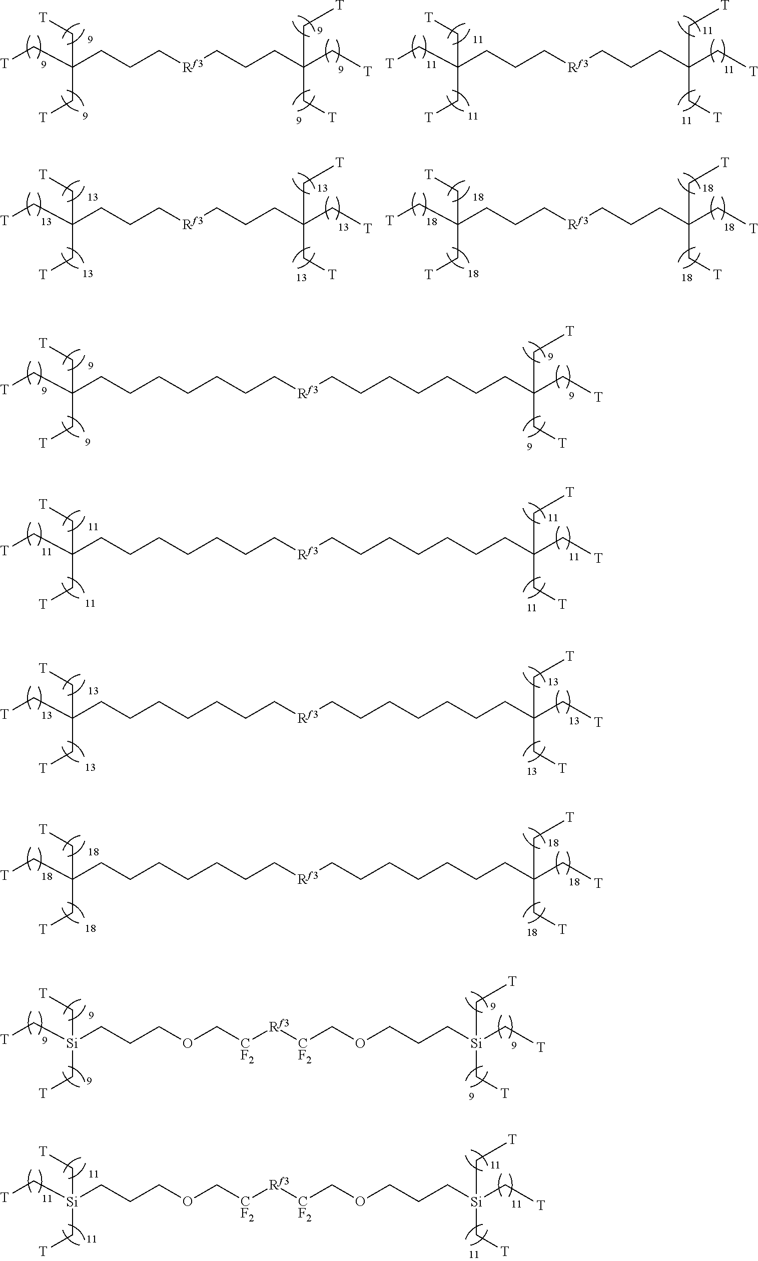

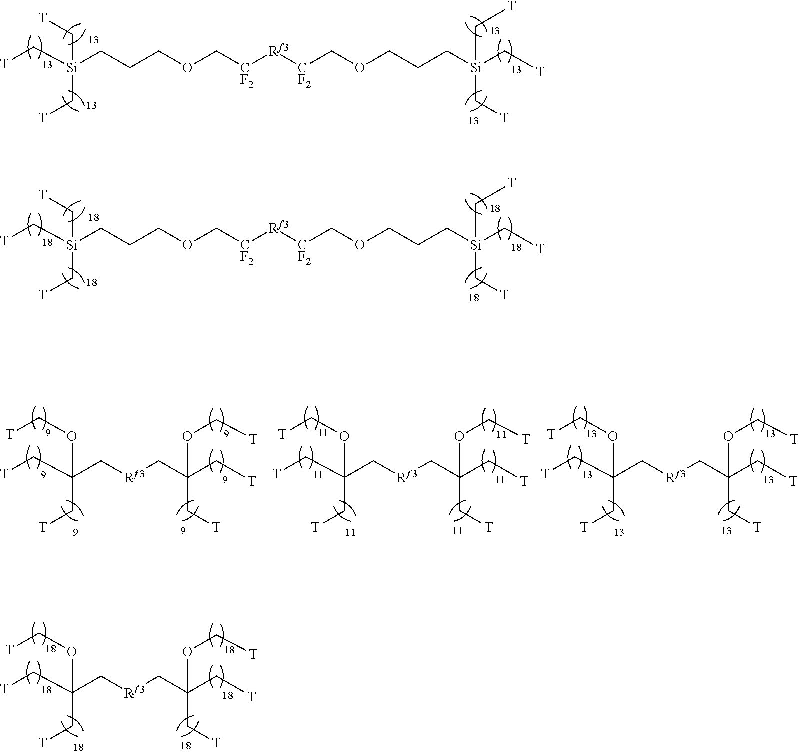

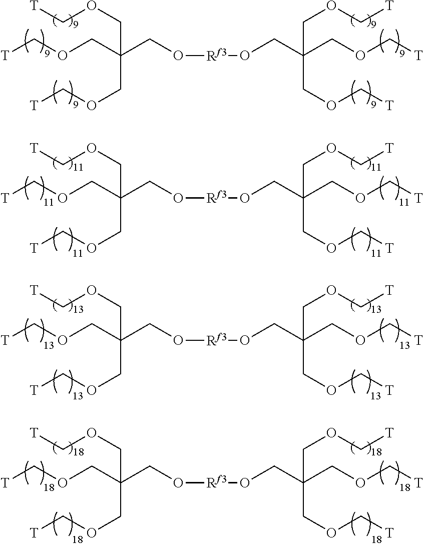

R^{f3} is each independently the same as [R³—(OR (12)_{y2}—O—R²] or [(OR^{f12})_{y2}—O—], and T is the same as T²¹ or T³¹.

### (Compound (A3))

The Compound (A3) has a structure represented by the following formula (A3).

Q¹[-(OR^{f13})_{y3}—O—R⁴-L⁴-(R⁴¹-T⁴¹)ₓ₄]ᵣ₁ (A3)

Symbols in the formula (A3) are as defined above.

R^{f13} and (OR^{f13})_{y3} are the same as R^{f11} and (OR^{f11})_{y1}, and their preferred embodiments are also the same.

R⁴ is the same as R¹, and its preferred embodiment is also the same.

R⁴¹ is the same as R¹¹, and its preferred embodiment is also the same. “Bonded to L¹” is read as “bonded to L⁴”. “Bonded to T¹¹” is read as “bonded to T⁴¹”.

As a specific example of the preferred embodiment of R⁴¹, it is preferred that at least one R⁴¹ has a carbon chain having four or more carbon atoms linked to one another and the carbon chain is linked to T⁴¹, and it is more preferred that when there is a plurality of R⁴¹, all of the plurality of R⁴¹ have a carbon chain having four or more carbon atoms linked to one another and the carbon chain is linked to T⁴¹. The preferred embodiment of the number of carbon atoms linked in the carbon chain is the same as R¹¹.

T⁴¹ is —SiR^{a41}_{z41}R^{a42}_{3-z41}, R^{a41}, R^{a42} and z41 are each independently the same as R^{a11}, R^{a12} and z11 constituting T¹¹, and their preferred embodiments are also the same.

Q¹ is a r1-valent group having a branch point, and r1 is 3 or 4.

The branch point constituting Q¹ (hereinafter referred to as “branch point P³”) may be N, C, Si or a cyclic structure. Q¹ may have one of such a branch point P³, or may have 2 or more of such branch points P³.

In a case where the branch point P³ is N, the branch point P³ is represented for example by N(—*)₃, or NR²⁹(—*)₂.

In a case where the branch point P³ is C, the branch point P³ may, for example, be C(—*)₄, CR²⁹(—*)₂, or C(R²⁹)₂(—*)₂.

In a case where the branch point P³ is Si, the branch point P³ may, for example, be Si(—*)₄, SiR²⁹(—*)₃, or Si(R²⁹)₂(—*)₂.

* is a binding site on the OR^{f13} side, and R²⁹ is a monovalent group. R²⁹ may, for example, be a hydrogen atom, a fluorine atom, a hydroxy group, an alkyl group, a fluoroalkyl group, or a fluoropolyether chain having no R⁴¹-T⁴¹.

The cyclic structure constituting the branch point P³ may be the same cyclic structure constituting the branch point P¹, and the cyclic structure may further have, as a substituent, in addition to the above substituent, at least one group selected from the group consisting of a fluorine atom, a fluoroalkyl group and a fluoropolyether chain having no R⁴¹-T⁴¹.

As Q¹, in view of easiness of production of the Compound (A3), preferred are groups represented by the following formulae (Q¹) to (Q⁶).

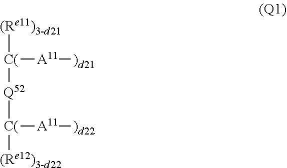

C(-A¹¹-)_{d23}(R^{e12})_{4-d23} (Q2)

N(-A¹²-)₃ (Q3)

Z′(-A¹³-)_{d24} (Q4)

Si(-A¹²-)_{d25}(R^{e13})_{4-d25} (Q5)

CH(-A¹¹-)₃-Si(R^{e13})_{3-d26}(-A¹¹-)_{d26} (Q6)

In the formulae (Q1) to (Q6), A¹¹, A¹² or A¹³ is linked to (OR^{f13}).
A¹¹ is a single bond, —R⁴⁰—, or -B¹³-R⁴⁰—, R⁴⁰ is an alkylene group, a fluoroalkylene group or a group having —C(O)NR^{e16}—, —C(O)—, —CO(O)—, —NR^{e16}— or —O— between carbon atoms of an alkylene group or fluoroalkylene group having 2 or more carbon atoms, B¹³ is —C(O)NR^{e16}—, —C(O)—, —NR^{e16}— or —O—,
A¹² is a single bond or —R⁴⁰—,
A¹³ is A¹¹ in a case where the atom in Z¹ to which A¹³ is bonded is a carbon atom, and is A¹² in a case where the atom in Z¹ to which A¹³ is bonded is a nitrogen atom,
Z¹ is a r1-valent group having a cyclic structure having a carbon atom or nitrogen atom to which A¹³ is directly bonded,
Q⁵² is a single bond, —O—, an alkylene group, a fluoroalkylene group, or a group having —C(O)NR^{e16}—, —C(O)—, —NR^{e16}— or —O— between carbon atoms in an alkylene group or a fluoroalkylene group having 2 or more carbon atoms,
R^{e11} is a hydrogen atom, a fluorine atom, an alkyl group, a fluoroalkyl group, a fluoropolyether chain having no R⁴¹-T⁴¹, or a group having a repeating structure of -Q⁵²-C(R^{e11})_{3-d21}(-A¹¹-)_{d21} within a range where r1 is 3 to 4,
R^{e12} is a hydrogen atom, a fluorine atom, a hydroxy group, an alkyl group, a fluoroalkyl group, or a fluoropolyether chain having no R⁴¹-T⁴¹
R^{e13} is an alkyl group or a fluoroalkyl group,
R^{e16} is a hydrogen atom, a C₁₋₆ alkyl group, a fluoroalkyl group or a phenyl group which may be substituted with fluorine,
d21 is an integer of 0 to 3, d22 is an integer of 0 to 3, and d21+d22 is an integer of 3 to 4,
d23 is 3 or 4,
d24 is 3 or 4,
d25 is 3 or 4, and
d26 is 1 or 2.

The direction of B¹³ is not limited. When there is a plurality of A¹¹, the plurality of A¹¹ may be the same or different from each other. The same applies to A¹², A¹³, R^{e11}, R^{e12} and R^{e13}.

The number of carbon atoms in the alkylene group or the fluoroalkylene group as R⁴⁰ is preferably 1 to 10, more preferably 1 to 6, further preferably 1 to 4, in view of easiness of production of the Compound (A3), and whereby the obtainable surface layer will be more excellent in abrasion resistance, light resistance and chemical resistance. In a case where the alkylene group has a specific bond between carbon atoms, the lower limit of the number of carbon atoms in such an alkylene group is 2.

The cyclic structure in Z¹ may be the cyclic structure constituting the branch point P³, and its preferred embodiment is also the same.

The number of carbon atoms in the alkylene group or the fluoroalkylene group as R^{e11}, R^{e12} or R^{e13} is, in view of easiness of production of the Compound (A3), preferably 1 to 6, more preferably 1 to 3, further preferably 1 to 2.

In the Compound (A3), the molecular weight of at least one of the groups represented by L⁴-(R⁴¹-T⁴¹)ₓ₄ is preferably 300 or more, more preferably 450 or more, further preferably 600 or more, whereby the obtainable surface layer will have more improved abrasion resistance.

On the other hand, the molecular weight is, in view of more excellent antifouling property, preferably 2,000 or less, more preferably 1,500 or less, further preferably 1,000 or less.

It is preferred that the molecular weights of all the groups represented by L⁴-(R⁴¹-T⁴¹)ₓ₄ are within the above range.

The ratio of the sum of the sum of the molecular weights of r1 pieces of groups represented by (OR^{f13})_{y3}—O—R⁴ and the molecular weight of the group represented by Q¹, to the sum of the molecular weights of r1 pieces of groups represented by L⁴-(R⁴¹-T⁴¹)ₓ₄, is preferably 10% or more, more preferably 12% or more, further preferably 13% or more, whereby the obtainable surface layer will have more improved abrasion resistance.

The upper limit of the above ratio is, in view of more excellent antifouling property, preferably 40% or less, more preferably 25% or less.

As the Compound (A3), the following may, for example, be mentioned.

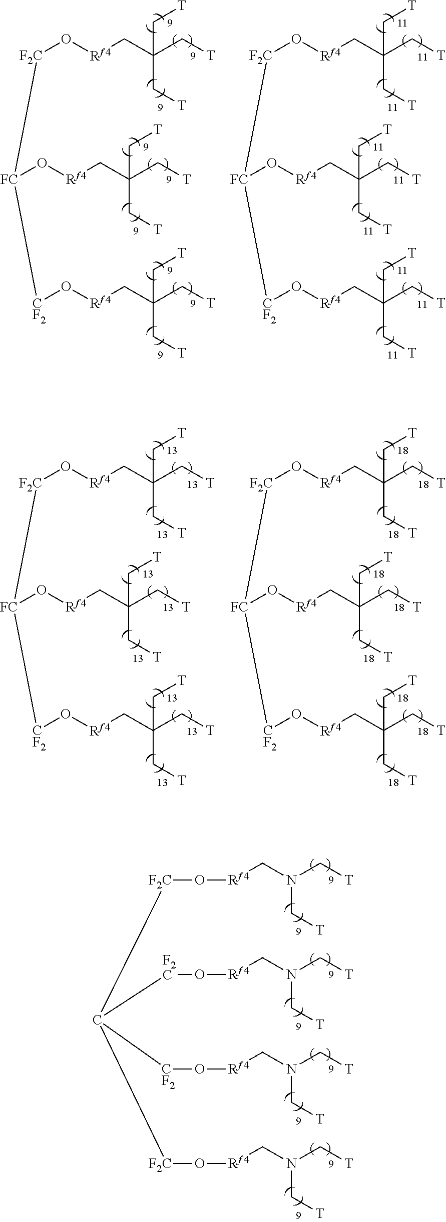

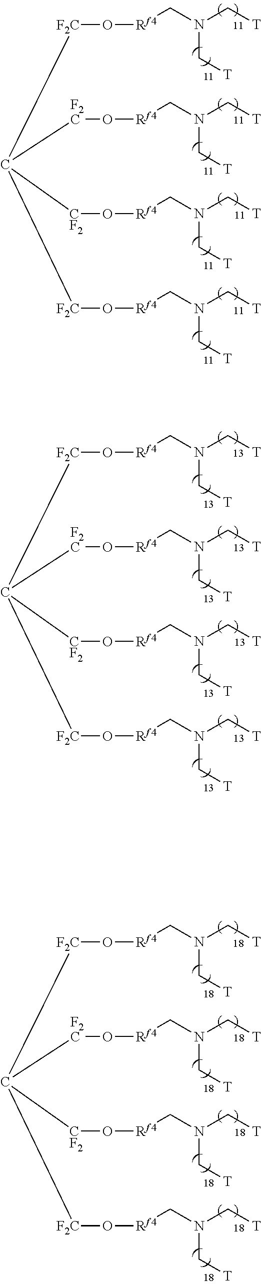

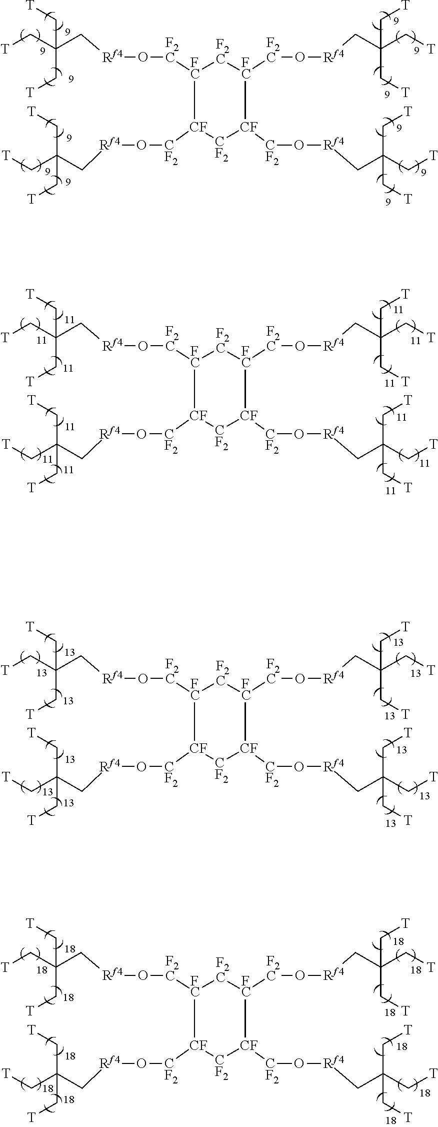

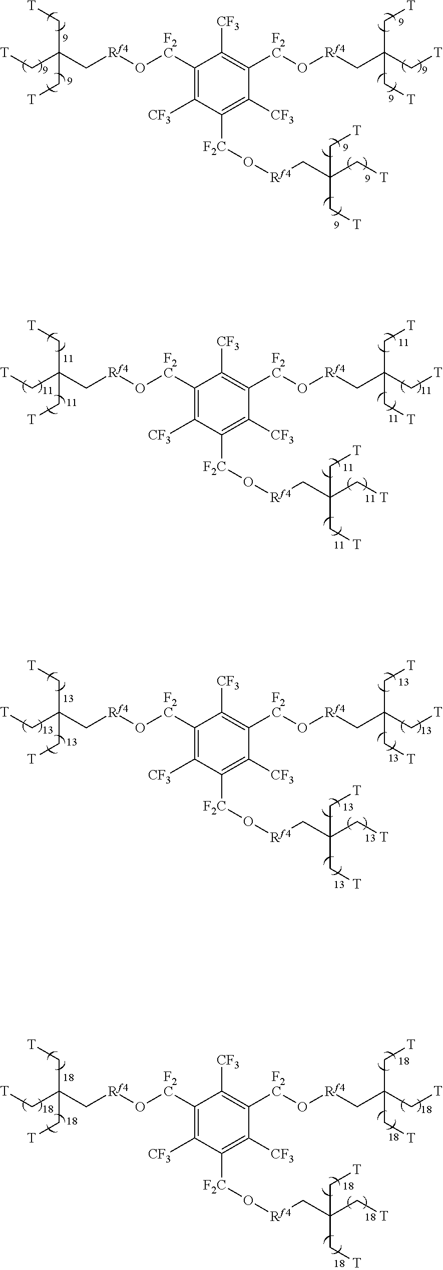

In the above compounds, {—O—R^{f4}-} is each independently the same as [—(OR^{f13})_{y3}—O—R⁴]ᵣ₁, or [—(OR^{f13})_{y3}—O—]ᵣ₁, and T is the same as T⁴¹.

The present composition may contain a single type of the first component or may contain 2 or more types of the first components.

The content of the first component is, to the total mass of the present composition, preferably 1 to 99 mass %, more preferably 5 to 95 mass %, further preferably 10 to 90 mass %.

The concentration of the first component to the total molar amount of the first component and the second component contained in the present composition is preferably 5 to 95 mol %, more preferably 10 to 90 mol %.

### <Second Component>

The second component contained in the composition of the present invention is at least one fluorinated ether compound selected from the group consisting of a Compound (B1) and a Compound (B2). The second component may contain both the Compound (B1) and the Compound (B2) or may contain only one of them.

R^{f14}—(OR^{f15})_{y4}—O—R⁵—R^{b1} (B1)

R^{f19}—(OR^{f18})_{y6}—O—R⁷-L^{b1}-R⁶—O—(R^{f16}O)_{y5}—R^{f17} (B2)

In the formula (B1),
R^{f14} is a C₁₋₂₀ fluoroalkyl group,
R^{f15} is a C₁₋₆ fluoroalkylene group, and when there is a plurality of R^{f15}, the plurality of R^{f15} may be the same or different from each other,
R⁵ is an alkylene group which may have a substituent,
R^{b1} is a hydrogen atom, a chlorine atom, a bromine atom, or an iodine atom, and
y4 is an integer of 1 or more.

In the formula (B2),
R^{f17} and R^{f19} are each independently a C₁₋₂₀ fluoroalkyl group,
R^{f16} and R^{f18} are each independently a C₁₋₆ fluoroalkylene group, when there is a plurality of R^{f16}, the plurality of R^{f16} may be the same or different from each other, and when there is a plurality of R^{f18}, the plurality of R^{f18} may be the same or different from each other,
R⁶ and R⁷ are each independently an alkylene group which may have a substituent,
L^{b1} is a single bond or a bivalent linking group (excluding (OR^{f18})_{y7} and (R^{f16}O)_{y8}, y7 and y8 are each independently an integer of 1 or more), and
y5 and y6 are each independently an integer of 1 or more.

### (Compound (B1))

The Compound (B1) is a compound represented by the formula (B1).

R^{f14}—(OR^{f15})_{y4}—O—R⁵—R^{b1} (B1)

Symbols in the formula (B1) are as defined above.

R^{f14} is a C₁₋₂₀ fluoroalkyl group.

The number of carbon atoms in the fluoroalkyl group is preferably 1 to 10, more preferably 1 to 6, particularly preferably 1 to 3, whereby the obtainable surface layer will be more excellent in water repellency.

The fluoroalkyl group may be any of linear, branched or cyclic.

The fluoroalkyl group is preferably a group having all hydrogen atoms in a fluoroalkyl group replaced with fluorine atoms (perfluoroalkyl group).

R^{f15} is a C₁₋₆ fluoroalkylene group.

The preferred embodiment of R^{f15} is the same as R^{f11} in the formula (A1). The preferred embodiment of (OR^{f15}) is the same as (OR^{f11}) the above formula (A1).

The number y4 of repetition of (OR^{f15}) is an integer of 1 or more. The preferred embodiment of y4 is the same as the number y1 of repetition of the above (OR^{f11}).

R⁵ is an alkylene group which may have a substituent.

The number of carbon atoms in the alkylene group which may have a substituent is preferably 1 to 30, more preferably 1 to 20, further preferably 1 to 10, particularly preferably 1 to 6. In a case where the substituent has a carbon atom, the number of the carbon atom in the substituent is not included in the number of carbon atoms in the alkylene group which may have a substituent.

The alkylene group which may have a substituent may be any of linear, branched and cyclic.

The substituent which the alkylene group may have may, for example, be a halogen atom, a hydroxy group or an amino group. The halogen atom may, for example, be a fluorine atom, a chlorine atom, a bromine atom, or an iodine atom and is preferably a fluorine atom. In a case where the alkylene group has a fluorine atom, the alkylene group, that is a fluoroalkylene group, may be a group having all hydrogen atoms in the fluoroalkylene group replaced with fluorine atoms (perfluoroalkylene group).

R⁵ is preferably a fluoroalkylene group, more preferably a fluoroalkylene group having a hydrogen atom (that is a fluoroalkylene group excluding a perfluoroalkylene group), further preferably —R^{fb1}—R^{b11}—R^{fb1} is a C₁₋₆ perfluoroalkylene group, R^{b11} is a non-substituted C₁₋₆ alkylene group, and R^{b11} is bonded to R^{b1}. The sum of the number of carbons in R^{fb1} and the number of carbon atoms in R^{b11} is the same as the above number of carbon atoms in R⁵.

R^{b1} is a hydrogen atom, a chlorine atom, a bromine atom, or an iodine atom.

R^{b1} is preferably a hydrogen atom, or an iodine atom, more preferably a hydrogen atom.

The Compound (B1) may be used in combination of 2 or more.

Specific examples of the Compound (B1) include the following. PFPE in the following compounds is the same as R^{f14}—(OR^{f15})_{y4}— in the formula (B1), and its preferred embodiment is also the same. R^{fb1} is a C₁₋₆ perfluoroalkylene group, and represents the partial structure of R⁵ in the formula (B1). X in the following compounds is the same as R^{b1} in the formula (B1), and its preferred embodiment is also the same. R in the following compound is the same as the substituent which the alkylene group which may have a substituent represented by R⁵ in the formula (B1) may have, and its preferred embodiment is also the same.

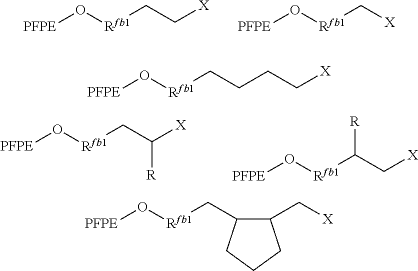

The method for producing the Compound (B1) is not particularly limited and description in WO2013/121984 may be mentioned.

### (Compound (B2))

The Compound (B2) is a compound represented by the formula (B2).

R^{f19}—(OR^{f18})_{y6}—O—R⁷-L^{b1}-R⁶—O—(R^{f16}O)_{y5}—R^{f17} (B2)

Symbols in the formula (B2) are as defined above.

R^{f17} and R^{f19} are each independently a C₁₋₂₀ fluoroalkyl group. The preferred embodiments of R^{f17} and R^{f19} are the same as R^{f14} in the above formula (B1).

R^{f16} and R^{f18} are each independently a C₁₋₆ fluoroalkylene group. The preferred embodiments of R^{f16} and R^{f18} are the same as R^{f15} in the above formula (B1).

The number y5 of repetition of (R^{f16}O) is an integer of 1 or more. The preferred embodiment of y5 is the same as the number y4 of repetition of the above (OR^{f15}).

The number y6 of repetition of (OR^{f18}) is an integer of 1 or more. The preferred embodiment of y6 is the same as the number y4 of repetition of the above (OR^{f15}).

In view of more excellent effects of the present invention, R^{f16} and R^{f18} in the formula (B2) are preferably the same as R^{f11} in the formula (A1), R^{f12} the formula (A2) and R^{f13} in the formula (A3), as the first component.

R⁶ and R⁷ are an alkylene group which may have a substituent. The preferred embodiments of R⁶ and R⁷ are the same as R⁵ in the above formula (B1).

The total number of carbon atoms in the alkylene group which may have a substituent as R⁶ and the alkylene group which may have a substituent as R⁷ is preferably 2 to 40, more preferably 2 to 20, further preferably 2 to 16. In a case where the substituent has a carbon atom, the number of the carbon atom in the substituent is not included in the number of carbon atoms in the alkylene group which may have a substituent.

R⁶ and R⁷ may be the same group or may be different groups, and are preferably the same group.

R⁶ is preferably a fluoroalkylene group, more preferably a fluoroalkylene group having a hydrogen atom (that is a fluoroalkylene group excluding a perfluoroalkylene group), further preferably —R^{fb2}—R^{b12}—R^{fb2} is a C₁₋₆ perfluoroalkylene group, R^{b12} is a non-substituted C₁₋₆ alkylene group, and R^{b12} is bonded to L^{b1} (R⁶ in a case where L^{b1} is a single bond). The sum of the number of carbon atoms in R^{fb2} and the number of carbon atoms in R^{b12} is the same as the number of carbon atoms in R⁶.

R⁷ is preferably a fluoroalkylene group, more preferably a fluoroalkylene group having a hydrogen atom (that is a fluoroalkylene group excluding a perfluoroalkylene group), further preferably —R^{b13}—R^{fb3}—R^{fb3} is a C₁₋₆ perfluoroalkylene group, R^{b13} is a non-substituted C₁₋₆ alkylene group, and R^{b13} is bonded to L^{b1} (R⁷ in a case where L^{b1} is a single bond). The sum of the number of carbon atoms in R^{fb3} and the number of carbon atoms in R^{b13} is the same as the number of carbon atoms in R⁷.

L^{b1} is a single bond or a bivalent linking group (excluding (OR^{f18})_{y7} and (R^{f16}O)_{y8}, and y7 and y8 are each independently an integer of 1 or more).

Specific examples of the bivalent linking group include an alkylene group, an etheric oxygen atom, an amide bond and a group having these combined with each other. Among the bivalent linking groups, preferred are an alkylene group, a group having an alkylene group and an etheric oxygen atom combined, and a group having an alkylene group and an amide bond combined, with a view to easily producing the Compound (B2) and in view of thermal stability and chemical stability.

The bivalent linking group as L^{b1} does not include (OR^{f18})_{y7} and (R^{f16}O)_{y8}. The definitions of (OR^{f18}) and (R^{f16}O) are as defined above, and y7 and y8 are each independently an integer of 1 or more

L^{b1} is, in view of more excellent effects of the present invention, preferably a single bond.

The Compound (B2) may be used in combination of 2 or more.

Specific examples of the Compound (B2) include the following. PFPE in the following compounds is the same as R^{f19}—(OR^{f18})_{y6}— or —(R^{f16}O)_{y5}—R^{f17} in the formula (B2), and its preferred embodiment is also the same. R^{fb2} is a C₁₋₆ perfluoroalkylene group and represents the partial structure of R⁶ in the formula (B2). R^{fb3} is a C₁₋₆ perfluoroalkylene group and represents the partial structure of R⁷ in the formula (B2). R in the following compounds is the same as the substituent which the alkylene group which may have a substituent represented by R⁶ and R⁷ in the formula (B2) may have, and its preferred embodiment is also the same.

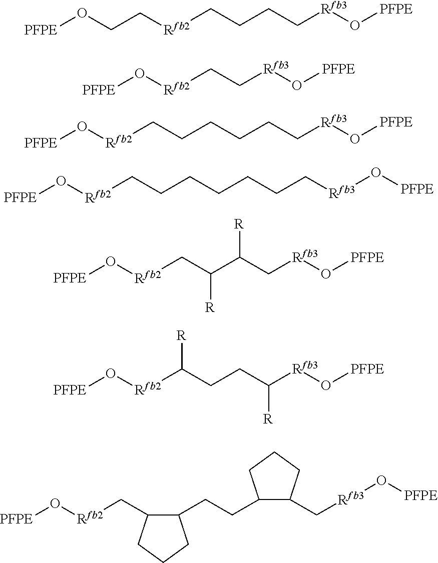

The method for producing the Compound (B2) is not particularly limited and may be a method of subjecting Compounds (B1) to a known coupling reaction.

### <Liquid Medium>

The composition of the present invention may be a composition to be used for dry coating method or may be a composition to be used for wet coating method.

In a case where the composition of the present invention is a composition to be used for wet coating method, the composition of the present invention preferably contains a liquid medium.

Specific examples of the liquid medium include water and an organic solvent.

The liquid medium preferably contains an organic solvent, and in view of excellent coating property, it more preferably contains an organic solvent having a boiling point of 35 to 250° C. The boiling point means the standard boiling point.

Specific examples of the organic solvent include a fluorinated organic solvent and a non-fluorinated organic solvent, and in view of excellent solubility, a fluorinated organic solvent is preferred. The organic solvent may be used singly or in combination of 2 or more.

Examples of the fluorinated organic solvent include a fluorinated alkane, a fluorinated aromatic compound, a fluoroalkyl ether, a fluorinated alkylamine, a fluoroalcohol and a hydrofluoroolefin.

The fluorinated alkane is preferably a C₄₋₈ compound. Examples of commercial products include C₆F₁₃H (manufactured by AGC Inc., ASAHIKLIN (registered trademark) AC-2000), C₆F₁₃C₂H₅ (manufactured by AGC Inc., ASAHIKLIN (registered trademark) AC-6000), and C₂F₅CHFCHFCF₃ (manufactured by Chemours, Vertrel (registered trademark) XF).

Examples of the fluorinated aromatic compound include hexafluorobenzene, trifluoromethylbenzene, perfluorotoluene and bis(trifluoromethyl)benzene.

The fluoroalkyl ether is preferably a C₄₋₁₂ compound. Examples of commercial products include CF₃CH₂OCF₂CF₂H (manufactured by AGC Inc., ASAHIKLIN (registered trademark) AE-3000), C₄F₉OCH₃ (manufactured by 3M, Novec (registered trademark) 7100), C₄F₉OC₂H₅ (manufactured by 3M, Novec (registered trademark) 7200), and C₂F₅CF(OCH₃) C₃F₇ (manufactured by 3M, Novec (registered trademark) 7300).

Examples of the fluorinated alkylamine include perfluorotripropylamine and perfluorotributylamine.

Examples of the fluoroalcohol include 2,2,3,3-tetrafluoropropanol, 2,2,2-trifluoroethanol and hexafluoroisopropanol.

Specific examples of the hydrofluoroolefin include 1-chloro-2,3,3-trifluoro-1-propene (HCFO-1233 yd), a reaction product of methanol with 1,1,1,2,2,3,4,5,5,6,6,7,7,7-tetradecafluoro-3-heptene, and a reaction product of methanol with 1,1,1,2,3,4,4,5,5,6,6,7,7,7-tetradecafluoro-3-heptene. Commercial products include AMOLEA (registered trademark) AS-300 manufactured by AGC Inc., and Opteon (registered trademark) (SF01, SF05, SF10, SF30, SF33, SF70, SF79, SF80) manufactured by Chemours.

The non-fluorinated solvent is preferably a compound composed solely of hydrogen atoms and carbon atoms, or a compound composed solely of hydrogen atoms, carbon atoms and oxygen atoms, and may, for example, be specifically a hydrocarbon-based organic solvent, a ketone-based organic solvent, an ether-based organic solvent, an ester-based organic solvent, an alcohol-based organic solvent, an amide-based organic solvent, or a sulfoxide-based organic solvent.

The hydrocarbon-based organic solvent is a compound composed solely of hydrogen atoms and carbon atoms and may be any of an aromatic hydrocarbon, an aliphatic hydrocarbon and an unsaturated hydrocarbon.

The aromatic hydrocarbon may, for example, be benzene, toluene or xylene.

The aliphatic hydrocarbon may, for example, be n-hexane, n-heptane, n-octane or n-decane.

The unsaturated hydrocarbon may, for example, be cyclopentene, hexene, heptene or butene.

Specific examples of the ketone-based organic solvent include acetone, methyl ethyl ketone, methyl isobutyl ketone, 2-hexanone, cyclohexanone, methyl amino ketone, 2-heptanone, diisobutyl ketone and diacetone alcohol.

Specific examples of the ether-based organic solvent include diethyl ether, diisopropyl ether, methyl t-butyl ether, dimethoxyethane, 1,4-dioxane, 1,3-dioxolane, tetrahydrofuran, cyclopentyl methyl ether, 4-methyltetrahydrofuran, 2-methyltetrahydrofuran, and a glycol-based solvent.

The glycol-based solvent may, for example, be a mono- or di-alkylene glycol mono- or di-alkyl ether, or a mono- or di-alkylene glycol mono- or di-alkyl ether acetate. The alkylene group is preferably an ethylene group or a propylene group. The alkyl group is preferably a C₁₋₄ alkyl group, more preferably a methyl group or an ethyl group. The glycol-based solvent may, for example, be more specifically ethylene glycol monomethyl ether, ethylene glycol monoethyl ether, propylene glycol monomethyl ether, propylene glycol monoethyl ether or propylene glycol monobutyl ether.

Specific examples of the ester-based organic solvent include ethyl acetate, isopropyl acetate, butyl acetate, amyl acetate, methyl formate, methyl butyrate, butyl butyrate, methyl lactate, ethyl lactate, methyl 3-methoxypropionate, ethyl 3-methoxypropionate, methyl 2-hydroxyisobutyrate, ethyl 2-hydroxyisobutyrate, and an esterified compound of the glycol-based solvent and a carboxylic acid such as acetic acid.

Specific examples of the alcohol-based organic solvent include methanol, ethanol, propanol, isopropanol and butanol. The glycol-based solvent is not included in the alcohol-based solvent.

The amide-based organic solvent may, for example, be N,N-dimethylformamide.

The sulfoxide-based organic solvent may, for example, be dimethyl sulfoxide.

### <Other Components>

The composition of the present invention may contain components other than the above within a range not to impair the effects of the present invention.

Such other components include compounds inevitable in production, such as by-products formed in the processes for producing the first component and the second component, and unreacted materials.

### <Content>

The content of the first component is, in view of more excellent effects of the present invention, to the total solid content by mass of the composition of the present invention, preferably 20 to 99 mass %, more preferably 30 to 90 mass %, further preferably 40 to 80 mass %, particularly preferably 50 to 80 mass %.

The content of the second component is, in view of more excellent effects of the present invention, to the total solid content by mass of the composition of the present invention, preferably 1 to 80 mass %, more preferably 10 to 70 mass %, further preferably 20 to 60 mass %, particularly preferably 20 to 50 mass %. The content of the second component means the total content of the Compound (B1) and the Compound (B2), and in a case where the second component is composed of only one of them, the content means the content of the single compound.

The mass of the solid content of the composition is, in a case where the composition contains the liquid medium, the mass excluding the liquid medium from the composition.

The mass ratio of the content of the second component to the content of the first component (the content of the second component/the content of the first component) is preferably 0.01 to 4.00, more preferably 0.01 to 1.50, further preferably 0.01 to 1.00, particularly preferably 0.01 to 0.50. When the mass ratio is within the above range, the obtainable surface layer will be more excellent in abrasion resistance.

In a case where the composition of the present invention contains the above liquid medium, the content of the liquid medium is, to the total mass of the composition of the present invention, preferably 70 to 99.99 mass %, more preferably 80 to 99.9 mass %.

The content of other components in the composition of the present invention is, to the content of the specific fluorinated ether compound, preferably 0 to 10 mass %, more preferably 0 to 5 mass %, further preferably 0 to 1 mass %.

[Substrate with Surface Layer]

The substrate with a surface layer of the present invention has a substrate and a surface layer formed of the above composition. The substrate with a surface layer of the present invention, which has a surface layer formed of the above composition, is excellent in abrasion resistance and is also excellent in water/oil repellency.

### (Substrate)

The substrate is not particularly limited so long as it is a substrate to be used as touched by another article (such as a stylus) or human fingers, a substrate to be held by human hands at the time of operation, and/or a substrate to be placed on another article (such as a holder), which is required to have water/oil repellency imparted. Specific examples of the material of the substrate include a metal, a resin, glass, sapphire, a ceramic, a stone and a composite material thereof. The glass may be chemically tempered.

The substrate is preferably a substrate for a touch panel or a substrate for a display, and is more preferably a substrate for a touch panel. The substrate for a touch panel preferably has optical transparency. “Having optical transparency” means the vertical incidence visible light transmittance in accordance with JIS R3106:1998 (ISO 9050:1990) of 25% or more. As a material of the substrate for a touch panel, glass or a transparent resin is preferred.

The substrate is also preferably a glass sheet or a resin film to be used for building materials, decorative building materials, interior materials, transport vehicles (such as automobiles), signboards/bulletin boards, beverage containers/dishware, fish Tank, decorative equipment (such as frames and boxes), laboratory tools, furniture, and art/sports/games, or a glass sheet or a resin film to be used for exterior portions (excluding display portions) of e.g. mobile phones (such as smartphones), personal digital assistants, gaming machines and remote controls.

The substrate may have surface treatment such as corona discharge treatment, plasma treatment or plasma graft polymerization treatment applied to one or both surfaces.

The surface layer may be formed directly on the surface of the substrate, or may be formed on the substrate via another film formed on the surface of the substrate. Specific examples of such another film include a primary layer formed on the surface of a substrate prepared by conducting surface pretreatment on the substrate with a compound as described in WO2011/016458, paragraphs 0089 to 0095, or SiO₂ or the like.

### (Surface Layer)

The surface layer is a layer formed of the above composition.

The surface layer contains, as described above, a condensate obtained by hydrolysis and dehydration condensation reaction of a part of or the whole of reactive silyl groups of the specific fluorinated ether compound as the first component. The surface layer also contains the above second component or a component derived therefrom.

The thickness of the surface layer is preferably 1 to 100 nm, more preferably 1 to 50 nm. When the thickness of the surface layer is the lower limit value or more, effects by the surface layer will sufficiently be obtained. When the thickness of the surface layer is the above upper limit value or less, high utilization efficiency will be achieved.

The thickness of the surface layer may be calculated from the period of oscillation of an interference pattern of reflected X-rays obtained by an X-ray diffractometer for thin film analysis by X-ray reflectometry (XRR).

[Method for Producing Substrate with Surface Layer]

The method for producing a substrate with a surface layer of the present invention may be a method of forming a surface layer on a substrate using the above composition by dry coating method or wet coating method.

The substrate with a surface layer of the present invention may be produced, for example, by the following method.
A method of treating the surface of a substrate by dry coating method with the above composition containing no liquid medium (hereinafter sometimes referred to as “dry coating composition”) to obtain a substrate with a surface layer having a surface layer formed on the surface of the substrate.
A method of coating the surface of a substrate with the above composition containing a liquid medium (hereinafter sometimes referred to as “wet coating composition”) by wet coating method, followed by drying to obtain a substrate with a surface layer having a surface layer formed on the surface of the substrate.

Specific examples of the dry coating method include vacuum deposition method, CVD method and sputtering method. Among them, with a view to suppressing decomposition of the specific fluorinated ether compound and in view of apparatus simplicity, vacuum deposition method is suitable. At the time of vacuum deposition, a pelletized substance having the dry coating composition supported on a metal porous body of iron, steel of the like, or a pelletized substance obtained by impregnating a metal porous body with the wet coating composition, followed by drying, may be used.

Specific examples of the wet coating method include spin coating method, wipe coating method, spray coating method, squeegee coating method, dip coating method, die coating method, ink jetting method, flow coating method, roll coating method, casting method, Langmuir-Blodgett method and gravure coating method.

The drying temperature after wet coating with the composition is preferably 20 to 200° C., particularly preferably 80 to 160° C.

### EXAMPLES

Now, the present invention will be described in detail with reference to Examples. Examples 1-1 to 1-12 and Examples 2-1 to 2-12 are Examples of the present invention, and Examples 1-13 and 2-13 are Comparative Examples. It should be understood that the present invention is by no means restricted to such specific Examples. Amounts of the respective components in Tables described later are based on mass.

### [Synthesis of Compound A1-1]

### <Synthesis of Compound X1>

Into a reactor, 2.0 g of dimethyl malonate, 10.6 g of 11-bromo-1-undecene (CH₂═CH(CH₂)₉—Br), 8.4 g of potassium carbonate and 50.0 g of dimethylformamide (DMF) were put and stirred in a nitrogen atmosphere at 85° C. After completion of the reaction, hydrochloric acid was added, an organic phase was recovered, and the recovered organic phase was concentrated by an evaporator to obtain 6.1 g of Compound X1.

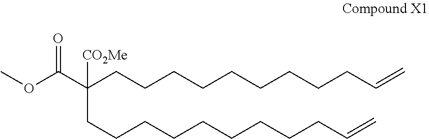

In the formula, Me is a methyl group.

### <Synthesis of Compound X2>

Into a reactor, 6.1 g of Compound X1, 24.4 g of dimethyl sulfoxide (DMSO), 2.4 g of lithium chloride and 3.27 g of water were put and stirred in a nitrogen atmosphere at 180° C. After completion of the reaction, hydrochloric acid was added, an organic phase was recovered, and the recovered organic phase was concentrated by an evaporator and subjected to silica gel column chromatography to obtain 4.0 g of Compound X2.

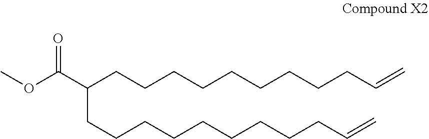 [SMILES: C=CCCCCCCCCCC(CCCCCCCCCC=C)C(=O)OC]

### <Synthesis of Compound X3>

Into a reactor, 2.0 g of Compound X2, 20.0 g of dehydrated tetrahydrofuran (THF), 6.6 mL of 2.0M lithium diisopropylamide (THF solution) and 3.1 g of 11-bromo-1-undecene (CH₂═CH(CH₂)₉—Br) were put and stirred in a nitrogen atmosphere at about-70° C. After completion of the reaction, hydrochloric acid was added, an organic phase was recovered, and the recovered organic phase was concentrated by an evaporator and subjected to silica gel column chromatography to obtain 2.1 g of Compound X3.

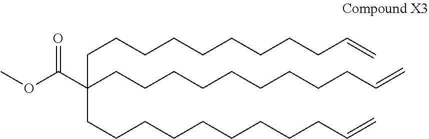 [SMILES: C=CCCCCCCCCCC(CCCCCCCCCC=C)(CCCCCCCCCC=C)C(=O)OC]

### <Synthesis of Compound X4>

Into a reactor, 0.89 g of lithium aluminum hydride and 25 g of dehydrated THF were put and stirred in a nitrogen atmosphere at 0° C. Then, 2.5 g of Compound X3 was put and stirred in a nitrogen atmosphere at 0° C. After completion of the reaction, water and 1M sodium hydroxide were put, an organic phase was recovered, and the recovered organic phase was concentrated by an evaporator and subjected to silica gel column chromatography to obtain 2.0 g of Compound X4.

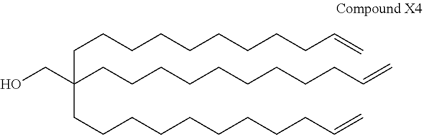 [SMILES: C=CCCCCCCCCCC(CO)(CCCCCCCCCC=C)CCCCCCCCCC=C]

### <Synthesis of Compound X5>

Using the above Compound X4, in accordance with the method in Examples 1 and 2 of WO2021/054413, the following Compound X5 was obtained.

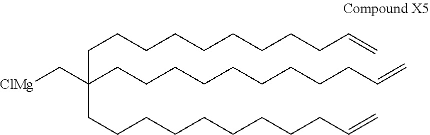

### <Synthesis of Compound X7>

1.03 g of the following Compound B1-1 was suspended in 5 mL of dehydrated THF, 0.0025 g of copper chloride was added and stirred at room temperature (25° C.). To the mixed solution, 1.15 g of the above Compound X5 adjusted to 17 mass % was slowly added dropwise, followed by stirring at 55° C. The mixed solution was cooled to room temperature (25° C.), water was added, extraction was conducted with 5 mL of AE-3000 (manufactured by AGC Inc., ASAHIKLIN (registered trademark) AE-3000), and sodium sulfate was added. After filtration, the solvent was distilled off. By conducting flash column chromatography with silica gel, a mixture containing Compound Y6 was obtained. It was confirmed by NMR measurement that Compound X7 was obtained with a selectivity of 79%. In the formula, the average of the number n of repeating units is 13.

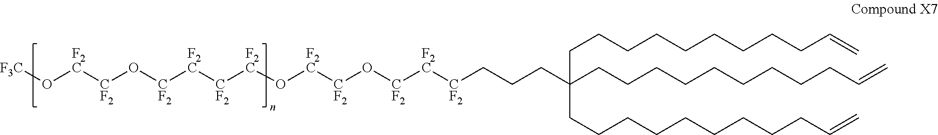

### <Synthesis of Compound A1-1>

Into a reactor the interior of which was replaced with nitrogen, 2.0 g of Compound X7, 2.0 g of AC-6000, 0.12 g of a xylene solution of a platinum/1,3-divinyl-1,1,3,3-tetramethyldisiloxane complex (platinum content: 3%). 0.28 g of HSi(OCH₃)₃ and 0.02 g of aniline were put and stirred at 40° C. After completion of the reaction, the solvent and the like were distilled off under reduced pressure, and the residue was filtrated through a membrane filter with a pore size of 0.2 μm to obtain 2.1 g of Compound A1-1. In the formula, the average of the number n of repeating units is 13.

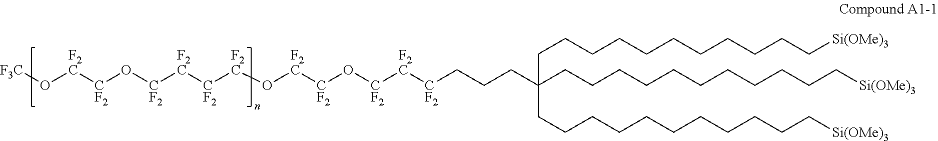

In the formula, Me is a methyl group.

### [Synthesis of Compound B1-1]

Compound B1-1 was obtained in accordance with the method described in Example 11 of WO2013/121984.

CF₃—(OCF₂CF₂—OCF₂CF₂CF₂CF₂)ₙ(OCF₂CF₂)—OCF₂CF₂CF₂—CH₂CH₂I (B1-1)

In the formula, the average of the number n of repeating units is 13.

### [Synthesis of Compound B1-2]

Into a flask, 3.0 g of the above Compound B1-1, 22 mg of azobisisobutyronitrile, 6.0 g of 1,3-bis(trifluoromethyl)benzene and 574 mg of tributyltin hydride were put and stirred at 70° C. for 2 hours. After the mixture was cooled to room temperature (25° C.), the obtained reaction solution was purified by silica gel column chromatography to obtain 2.3 g of Compound B1-2.

NMR spectrum data of Compound B1-2;

¹H-NMR (400 MHZ, Chloroform-d) δ (ppm): 2.30 to 2.13 (m, 2H), 1.27 (t, J=7.1 Hz, 3H)

¹⁹F-NMR (376 MHz, Chloroform-d) δ (ppm): −55.25, −82.83, −88.06, −90.16 (d, J=8.1 Hz), −116.52, −125.26, −126.59.

CF₃—(OCF₂CF₂—OCF₂CF₂CF₂CF₂)ₙ(OCF₂CF₂)—OCF₂CF₂CF₂—CH₂CH₃ (B1-2)

In the formula, the average of the number n of repeating units is 13.

### [Synthesis of Compound B2-1]

In an argon atmosphere, 3.0 g of the above Compound B1-1, 104 mg of metal copper and 3.0 mL of DMSO were put into a flask and stirred at 150° C. for 16 hours.

After the obtained reaction solution was cooled to room temperature (25° C.), it was purified by silica gel column chromatography to obtain 2.1 g of Compound B2-1. In the formula, the average of the number n of repeating units is 13.

NMR spectrum data of Compound B2-1;

¹H-NMR (400 MHZ, Chloroform-d) δ (ppm): 2.31 to 2.14 (m, 4H), 1.91 to 1.78 (m, 4H)

¹⁹F-NMR (376 MHZ, Chloroform-d) δ (ppm): −55.25, −82.83, −88.06, −90.16 (d, J=8.1 Hz), −114.33, −125.26, −126.59.

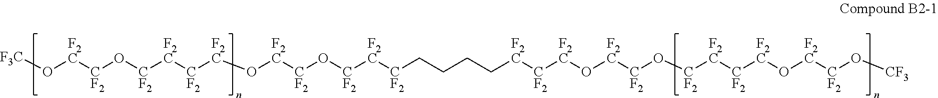

### [Synthesis of Compound C1-1]

### <Synthesis of Compound Y1>

60.0 g of diethyl diallyl malonate, 23.7 g (559 mmol) of lithium chloride, 6.45 g (360 mmol) of water and 263 g of DMSO were added and stirred at 160° C. After the mixture was cooled to room temperature (25° C.), water was added and extraction with ethyl acetate was conducted. Hexane was added to an organic layer, and the organic layer was washed with saturated salt solution and dried over sodium sulfate. After filtration, the solvent was distilled off to obtain 39.5 g of the following Compound Y1. In the formula, Et is an ethyl group.

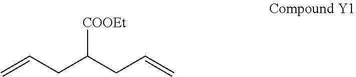

NMR spectrum data of Compound Y1;

¹H-NMR (400 MHZ, Chloroform-d) δ (ppm): (ddt, J=17.1, 10.1, 7.0 Hz, 2H), 5.06 to 4.94 (m, 4H), 4.09 (q, J=7.1 Hz, 2H), 2.47 (ddd, J=14.0, 8.0, 6.1 Hz, 1H), 2.33 (dt, J=14.9, 7.5 Hz, 2H), 2.22 (dt, J=14.1, 6.5 Hz, 2H), 1.21 (t, J=7.1 Hz, 3H).

### <Synthesis of Compound Y2>

260 mL of THF and 29.8 mL of diisopropylamine were added, and the solution was cooled to −78° C. 96.6 mL of n-butyllithium hexane solution (2.76 M) was added and warmed to 0° C. After stirring, the mixture was cooled to −78° C. to prepare a THF solution of lithium diisopropylamide (LDA). 39.5 g of the above Compound Y1 was added to the THF solution and stirred, and 24.1 mL of allyl bromide was added. The mixture was warmed to 0° C., 100 mL of 1M hydrochloric acid was added, and THF was distilled off under reduced pressure. Extraction with dichloromethane was conducted, and sodium sulfate was added. After filtration, the solvent was distilled off, and flash column chromatography with silica gel was conducted to obtain 45.0 g of Compound Y2. In the formula, Et is an ethyl group.

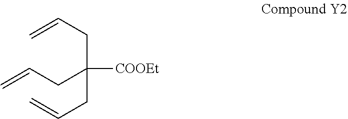

### NMR Spectrum Data of Compound Y2;

¹H-NMR (400 MHZ, Chloroform-d) δ (ppm): 5.74 to 5.62 (m, 3H), 5.04 (dd, J=13.6, 1.9 Hz, 6H), 4.10 (q, J=7.1 Hz, 2H), 2.29 (d, J=7.4 Hz, 6H), 1.22 (t, J=7.1 Hz, 3H).

### <Synthesis of Compound Y3>

45.0 g of the above Compound Y2 was dissolved in 620 mL of THF and cooled to 0° C. 104 mL of a THE solution of lithium aluminum hydride was added and stirred. Water and a 15% aqueous sodium hydroxide solution were added, and the mixture was stirred at room temperature (25° C.) and diluted with dichloromethane. After filtration, the solvent was distilled off, and flash column chromatography with silica gel was conducted to obtain 31.3 g of the following Compound Y3.

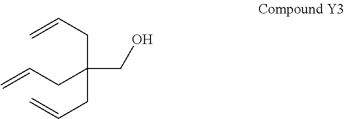

### NMR Spectrum Data of Compound Y3;

¹H-NMR (400 MHZ, Chloroform-d) δ (ppm): 5.90 to 5.76 (m, 3H), 5.10 to 5.02 (m, 6H), 3.38 (s, 2H), 2.03 (dt, J=7.5, 1.2 Hz, 6H), 1.45 (s, 1H).

### <Synthesis of Compound Y4>

380 mL of acetonitrile, 31.3 g of the above Compound Y3, 64.3 g of triphenylphosphine and 33.9 g of carbon tetrachloride were added and stirred at 90° C. After concentration, ethyl acetate and hexane were added and stirred. After filtration, the filtrate was concentrated and distilled to obtain 28.2 g of the following Compound Y4.

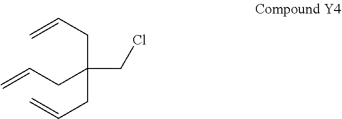

### NMR Spectrum Data of Compound Y4;

¹H-NMR (400 MHZ, Chloroform-d) δ (ppm): 5.83 to 5.67 (m, 3H), 5.16 to 5.01 (m, 6H), 3.32 (s, 2H), 2.05 (dt, J=7.5, 1.1 Hz, 6H).

### <Synthesis of Compound Y5>

35 mL of THF and 0.180 g of iodide were added to 2.36 g of magnesium and stirred at room temperature (25° C.). 14.0 g of the above Compound Y4 and 35 mL of THF were added and subjected to reflux with heating to obtain a solution (0.80M) of the following Compound Y5.

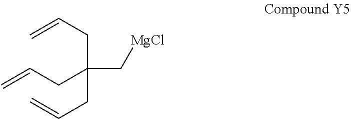

### NMR Spectrum Data of Compound Y5;

¹H-NMR (400 MHZ, Chloroform-d) δ (ppm): 5.88 (m, 3H), 5.11 (m, 6h), 1.85 (m, 6h), 1.22 (s, 2h).

### <Synthesis of Compound Y6>

1.03 g of the above Compound B1-1 was suspended in 5 mL of dehydrated THF, 0.0025 g of copper chloride was added and stirred at room temperature (25° C.). To the mixed solution, 0.31 g of the above Compound Y5 adjusted to 17 mass % was slowly added dropwise and stirred at 55° C. The mixed solution was cooled to room temperature (25° C.), water was added, extraction with 5 mL of AE-3000 was conducted, and sodium sulfate was added. After filtration, the solvent was distilled off. Flash column chromatography with silica gel was conducted to obtain a mixture containing Compound Y6. It was confirmed by NMR measurement that Compound Y6 was obtained with a selectivity of 84%. In the formula, the average of the number n of repeating units was 13.

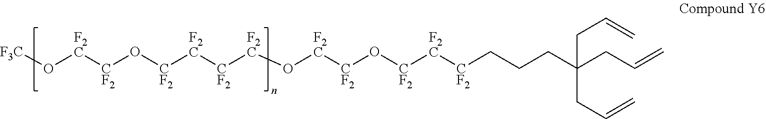

### NMR Spectrum Data of Compound Y6;

¹H-NMR (400 MHZ, Chloroform-d) δ (ppm): 5.80 (ddt, J=20.3, 9.3, 7.4 Hz, 3H), 5.01 (dd, J=13.5, 1.7 Hz, 6H), 2.13 to 2.01 (m, 2H), 1.97 (d, J=7.5 Hz, 6H), 1.67 to 1.55 (m, 2H), 1.27 to 1.18 (m, 2H).

¹⁹F-NMR (376 MHZ, Chloroform-d) δ (ppm): −55.25, −82.83, −88.06, −90.16 (d, J=8.1 Hz), −114.18, −125.26, −126.59.

### <Synthesis of Compound C1-1>

0.89 g of AC-2000, 0.139 g of Compound Y6, 5.5 mg of a xylene solution of a platinum/1,3-divnyl-1,1,3,3-tetramethyldisiloxane complex (platinum content: 2%), 0.8 mg of aniline and 22.7 mg (0.185 mmol) of trimethoxysilane were added, followed by stirring at 40° C., and the solvent was distilled off under reduced pressure to obtain 0.140 g of Compound C1-1. In the formula, the average of the number n of repeating units is 13.

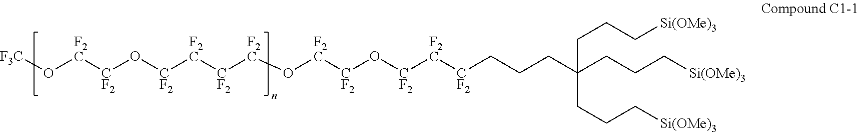

In the formula, Me is a methyl group.

### NMR Spectrum of Compound C1-1;

¹H-NMR (400 MHz, Chloroform-d) δ (ppm): 3.60 (s, 27H), 2.23-1.95 (m, 2H), 1.63-1.28 (m, 14H), 0.67 (t, J=7.6 Hz, 6H).

¹⁹F-NMR (376 MHz, Chloroform-d) δ (ppm): −55.33, −82.95, −88.17, −90.13-−90.40 (m), −114.07-−114.32 (m), −125.38, −126.04.

### Example 1-1

99 parts by mass of Compound A1-1 as the first component and 1 part by mass of Compound B1-1 as the second component were mixed to obtain composition (1-1).

On a molybdenum boat in a vacuum deposition apparatus (manufactured by ULVAC KIKO, Inc., VTR-350M), composition (1-1) (0.14 g) as a deposition source was disposed, and the vacuum deposition apparatus was evacuated of air until the pressure became 1×10⁻³ Pa or lower. The boat on which composition (1-1) was placed was heated at a heating rate of 10° C./min or less and at a point when the deposition rate as measured by a quartz crystal microbalance exceeded 1 nm/sec, the shutter was opened to start film formation on the surface of a substrate (chemically strengthened glass). At a point when the film thickness reached about 50 nm, the shutter was closed to terminate the film formation on the surface of the substrate. The substrate having composition (1-1) deposited was heat treated at 200° C. for 30 minutes and washed with dichloropentafluoropropane (manufactured by AGC Inc., AK-225) to obtain a substrate with a surface layer having the surface layer on the surface of the substrate.

### Examples 1-2 to 1-13

In the same manner as in Example 1-1 except that the type and the content of the first component and the second component were changed as identified in Tables 1 and 2, a substrate with a surface layer in each Example was obtained.

### [Evaluation Test]

The following evaluation tests were conducted using the substrates with a surface layer in Example 1-1 to Example 1-13 and Example 2-1 to Example 2-13.

### <Initial Water Contact Angle>

The water contact angle of about 2 μL of distilled water placed on the surface of the surface layer was measured by a contact angle measuring apparatus (manufactured by Kyowa Interface Science Co., Ltd., DM-701) at 20° C. Measurement was conducted on different three points on the surface of the surface layer, and the average value was calculated and taken as the initial water contact angle. To calculate the contact angle, 2θ method was employed. Based on the obtained initial water contact angle, water repellency was evaluated in accordance with the following evaluation standards.
A: contact angle of 115° or more
B: contact angle of 105° or more and less than 115°
C: contact angle of less than 105°

### <Abrasion Resistance>

On the surface layer, steel wool BONSTAR (grade #0000) was reciprocated under a pressure of 98.07 kPa at 320 cm/min using a reciprocating traverse testing machine (manufactured by KNT) in accordance with JIS L0849:2013 (ISO 105-X12:2001). After abrasion with the steel wool for 10,000 cycles, the water contact angle on the surface layer was measured and the abrasion resistance was evaluated based on the following evaluation standard. A smaller change as between before and after the abrasion test indicates a smaller decrease of the performance due to abrasion and more excellent abrasion resistance. Evaluation results of B or higher indicate excellent abrasion resistance.
A: change of water contact angle of less than 2°
B: change of water contact angle of 2° or more and less than 4°
C: change of water contact angle of 4° or more and less than 6°
D: change of water contact angle of 6° or more

### <Evaluation Results>

The results of the evaluation tests are shown in Tables 1 and 2.

The “second component/first component” row represents the mass ratio of the content of the second component to the content of the first component.

TABLE 1

| | Example | | 1-1 | 1-2 | 1-3 | 1-4 | 1-5 | 1-6 | 1-7 | 1-8 | 1-9 | 1-10 | 1-11 | 1-12 | 1-13 |
|---|---|---|---|---|---|---|---|---|---|---|---|---|---|---|---|
| First | Compound | Content | 99 | 99 | 80 | 60 | 40 | 99 | 80 | 60 | 40 | 98 | 98 | 60 | 100 |
| component | A1-1 | (parts | | | | | | | | | | | | | |
| | | by | | | | | | | | | | | | | |
| | | mass) | | | | | | | | | | | | | |
| Second | Compound | Content | 1 | 0 | 0 | 0 | 0 | 0 | 0 | 0 | 0 | 1 | 0 | 0 | 0 |
| component | B1-1 | (parts | | | | | | | | | | | | | |
| | | by | | | | | | | | | | | | | |
| | | mass) | | | | | | | | | | | | | |
| | Compound | Content | 0 | 1 | 20 | 40 | 60 | 0 | 0 | 0 | 0 | 1 | 1 | 20 | 0 |
| | B1-2 | (parts | | | | | | | | | | | | | |
| | | by | | | | | | | | | | | | | |
| | | mass) | | | | | | | | | | | | | |
| | Compound | Content | 0 | 0 | 0 | 0 | 0 | 1 | 20 | 40 | 60 | 0 | 1 | 20 | 0 |
| | B2-1 | (parts | | | | | | | | | | | | | |
| | | by | | | | | | | | | | | | | |
| | | mass) | | | | | | | | | | | | | |

| Second component/ | | 0.01 | 0.01 | 0.25 | 0.67 | 1.50 | 0.01 | 0.25 | 0.67 | 1.50 | 0.02 | 0.02 | 0.67 | 0.00 |
|---|---|---|---|---|---|---|---|---|---|---|---|---|---|---|
| first component | | | | | | | | | | | | | | |
| Evaluation | Initial water contact | A | A | A | A | A | A | A | A | A | A | A | A | A |
| results | angle | | | | | | | | | | | | | |
| | Abrasion resistance | A | A | A | A | B | A | A | A | B | A | A | A | D |

TABLE 2

| | Example | | 2-1 | 2-2 | 2-3 | 2-4 | 2-5 | 2-6 | 2-7 | 2-8 | 2-9 | 2-10 | 2-11 | 2-12 | 2-13 |
|---|---|---|---|---|---|---|---|---|---|---|---|---|---|---|---|
| First | Compound | Content | 99 | 99 | 80 | 60 | 40 | 99 | 80 | 60 | 40 | 98 | 98 | 60 | 100 |
| component | C1-1 | (parts | | | | | | | | | | | | | |
| | | by | | | | | | | | | | | | | |
| | | mass) | | | | | | | | | | | | | |
| Second | Compound | Content | 1 | 0 | 0 | 0 | 0 | 0 | 0 | 0 | 0 | 1 | 0 | 0 | 0 |
| component | B1-1 | (parts | | | | | | | | | | | | | |
| | | by | | | | | | | | | | | | | |
| | | mass) | | | | | | | | | | | | | |
| | Compound | Content | 0 | 1 | 20 | 40 | 60 | 0 | 0 | 0 | 0 | 1 | 1 | 20 | 0 |
| | B1-2 | (parts | | | | | | | | | | | | | |
| | | by | | | | | | | | | | | | | |
| | | mass) | | | | | | | | | | | | | |
| | Compound | Content | 0 | 0 | 0 | 0 | 0 | 1 | 20 | 40 | 60 | 0 | 1 | 20 | 0 |
| | B2-1 | (parts | | | | | | | | | | | | | |
| | | by | | | | | | | | | | | | | |
| | | mass) | | | | | | | | | | | | | |

| Second component/ | | 0.01 | 0.01 | 0.25 | 0.67 | 1.50 | 0.01 | 0.25 | 0.67 | 1.50 | 0.02 | 0.02 | 0.67 | 0.00 |
|---|---|---|---|---|---|---|---|---|---|---|---|---|---|---|
| first component | | | | | | | | | | | | | | |
| Evaluation | Initial water contact | A | A | A | A | A | A | A | A | A | A | A | A | A |
| results | angle | | | | | | | | | | | | | |
| | Abrasion resistance | A | A | A | B | B | A | A | B | B | A | A | B | D |

As shown in Tables 1 and 2, it was confirmed that a surface layer excellent in initial water contact angle and also excellent in abrasion resistance can be formed by using a composition containing a first component composed of at least one member selected from the group consisting of the Compound (A1), the Compound (A2) and the Compound (A3) and a second component composed of at least one member selected from the group consisting of the Compound (B1) and the Compound (B2).

It was confirmed that more excellent abrasion resistance can be achieved when the mass ratio of the content of the second component to the content of the first component is 0.01 to 0.50 (Examples 1-1 to 1-12, Examples 2-1 to 2-12).

It was confirmed that more excellent abrasion resistance was achieved (Example 1-4, Example 2-4) when:
in the formula (A1), at least one R¹¹ has a carbon chain having four or more carbon atoms linked to one another and the chain is linked to T¹¹;
in the formula (A2), at least one of the following conditions is satisfied that at least one R²¹ has a carbon chain having four or more carbon atoms linked to one another and the chain is linked to T²¹; and at least one R³¹ has a carbon chain having four or more carbon atoms linked to one another and the chain is linked to T³¹; and
in the formula (A3), at least one R⁴¹ has a carbon chain having four or more carbon atoms linked to one another and the chain is linked to T⁴¹ (Example 1-4, Example 2-4).

This application is a continuation of PCT Application No. PCT/JP2023/036909, filed on Oct. 11, 2023, which is based upon and claims the benefit of priority from Japanese Patent Application No. 2022-164546 filed on Oct. 13, 2022. The contents of those applications are incorporated herein by reference in their entireties.

What is claimed is:

1. A composition containing:
a first component composed of at least one fluorinated ether compound selected from the group consisting of a compound represented by the formula (A1), a compound represented by the formula (A2) and a compound represented by the formula (A3), and
a second component composed of at least one fluorinated ether compound selected from the group consisting of a compound represented by the formula (B1) and a compound represented by the formula (B2),
[R^{f1}—(OR^{f11})_{y1}—O—R¹]ⱼ-L¹-(R¹¹-T¹¹)ₓ₁ (A1)
(T³¹-R³¹)ₓ₃-L³-R³—(OR^{f12})_{y2}—O—R²-L²-(R²¹-T²¹)ₓ₂ (A2)
Q¹[—(OR^{f13})_{y3}—O—R⁴-L⁴-(R⁴¹-T⁴¹)ₓ₄]ᵣ₁ (A3)
R^{f14}—(OR^{f15})_{y4}—O—R⁵—R^{b1} (B1)
R^{f19}—(OR^{f18})_{y6}—O—R⁷-L^{b1}-R⁶—O—(R^{f16}O)_{y5}—R^{f17} (B2)
in the formula (A1),
R^{f1} is a C₁₋₂₀ fluoroalkyl group, and when there is a plurality of R^{f1}, the plurality of R^{f1} may be the same or different from each other,
R^{f11} is a C₁₋₆ fluoroalkylene group, and when there is a plurality of R^{f11}, the plurality of R^{f11} may be the same or different from each other,
R¹ is an alkylene group or a fluoroalkylene group, and when there is a plurality of R¹, the plurality of R¹ may be the same or different from each other,
L¹ is a single bond or a (j+x1)-valent group which may have N, O, S or Si and may have a branch point, and in which atoms bonded to R¹ and R¹¹ are each independently N, O, S, Si, a carbon atom constituting the branch point, or a carbon atom having a hydroxy group or an oxo group (═O),
R¹¹ is an alkylene group in which an atom bonded to L¹ may be an etheric oxygen atom, and which may have an etheric oxygen atom between carbon atoms, and when there is a plurality of R¹¹, the plurality of R¹¹ may be the same or different from each other,
T¹¹ is —SiR^{a11}_{z11}R^{a12}_{3-z11}, and when there is a plurality of T¹¹, the plurality of T¹¹ may be the same or different from each other,
R^{a11} is a hydroxy group or a hydrolysable group, and when there is a plurality of R^{a11}, the plurality of R^{a11} may be the same or different from each other,
R^{a12} is a non-hydrolysable group, and when there is a plurality of R^{a12}, the plurality of R^{a12} may be the same or different from each other,
j is an integer of 1 or more, and when j is 1, y1 is an integer of 2 or more, or R¹ is a fluoroalkylene group,
z11 is an integer of 1 to 3,
x1 is an integer of 1 or more, and
y1 is an integer of 1 or more, and when there is a plurality of y1, the plurality of y1 may be the same or different from each other,
in the formula (A2),
R^{f12} is a C₁₋₆ fluoroalkylene group, and when there is a plurality of R^{f12}, the plurality of R^{f12} may be the same or different from each other,
R² and R³ are each independently an alkylene group or a fluoroalkylene group,
L² is a single bond or a (1+x2)-valent group which may have N, O, S or Si and may have a branch point, and in which atoms bonded to R² and R²¹ are each independently N, O, S, Si, a carbon atom constituting the branch point, or a carbon atom having a hydroxy group or an oxo group,
L³ is a single bond or a (1+x3)-valent group which may have N, O, S or Si and may have a branch point, and in which atoms bonded to R³ and R³¹ are each independently N, O, S, Si, a carbon atom constituting the branch point, or a carbon atom having a hydroxy group or an oxo group,
R²¹ is an alkylene group in which an atom adjacent to L² may be an etheric oxygen atom, and which may have an etheric oxygen atom between carbon atoms, and when there is a plurality of R²¹, the plurality of R²¹ may be the same or different from each other,
R³¹ is an alkylene group in which an atom adjacent to L³ may be an etheric oxygen atom, and which may have an etheric oxygen atom between carbon atoms, and when there is a plurality of R³¹, the plurality of R³¹ may be the same or different from each other,
T²¹ and T³¹ are each independently —SiR^{a21}_{z21}R^{a22}_{3-z21}, when there is a plurality of T²¹, the plurality of T²¹ may be the same or different from each other, and when there is a plurality of T³¹, the plurality of T³¹ may be the same or different from each other,
R^{a21} is a hydroxy group or a hydrolysable group, and when there is a plurality of R^{a21}, the plurality of R^{a21} may be the same or different from each other,
R^{a22} is a non-hydrolysable group, and when there is a plurality of R^{a22}, the plurality of R^{a22} may be the same or different from each other,
z21 is an integer of 1 to 3,
x2 and x3 are each independently an integer of 1 or more, and
y2 is an integer of 1 or more, and when y2 is 1, R² is a fluoroalkylene group,
in the formula (A3),
Q¹ is a r1-valent group having a branch point,
R^{f13} is a C₁₋₆ fluoroalkylene group, and the plurality of R^{f13} may be the same or different from each other,
R⁴ is each independently an alkylene group or a fluoroalkylene group, and the plurality of R⁴ may be the same or different from each other,
L⁴ is a single bond or a (1+x4)-valent group which may have N, O, S or Si and may have a branch point, and in which atoms bonded to R⁴ and R⁴¹ are each independently N, O, S, Si, a carbon atom constituting the branch point, or a carbon atom having a hydroxy group or an oxo group, and the plurality of L⁴ may be the same or different from each other,
R⁴¹ is an alkylene group in which an atom adjacent to L⁴ may be an etheric oxygen atom, and which may have an etheric oxygen atom between carbon atoms, and the plurality of R⁴¹ may be the same or different from each other,
T⁴¹ is —SiR^{a41}_{z41}R^{a42}_{3-z41}, and the plurality of T⁴¹ may be the same or different from each other,
R^{a41} is a hydroxy group or a hydrolysable group, and the plurality of R^{a41} may be the same or different from each other,
R^{a42} is a non-hydrolysable group, and when there is a plurality of R^{a42}, the plurality of R^{a42} may be the same or different from each other,
z41 is an integer of 1 to 3,
x4 is an integer of 1 or more, and when there is a plurality of x4, the plurality of x4 may be the same or different from each other,
y3 is an integer of 1 or more, and when there is a plurality of y3, the plurality of y3 may be the same or different from each other, and
r1 is 3 or 4,
in the formula (B1),
R^{f14} is a C₁₋₂₀ fluoroalkyl group,
R^{f15} is a C₁₋₆ fluoroalkylene group, and when there is a plurality of R^{f15}, the plurality of R^{f15} may be the same or different from each other,
R⁵ is an alkylene group which may have a substituent,
R^{b1} is a hydrogen atom, a chlorine atom, a bromine atom or an iodine atom, and
y4 is an integer of 1 or more,
in the formula (B2),
R^{f17} and R^{f19} are each independently a C₁₋₂₀ fluoroalkyl group,
R^{f16} and R^{f18} are each independently a C₁₋₆ fluoroalkylene group, when there is a plurality of R^{f16}, the plurality of R^{f16} may be the same or different from each other, and when there is a plurality of R^{f18}, the plurality of R^{f18} may be the same or different from each other,
R⁶ and R⁷ are each independently an alkylene group which may have a substituent,
L^{b1} is a single bond or a bivalent linking group (excluding (OR^{f18})_{y7} and (R^{f16}O)_{y8}, y7 and y8 are each independently an integer of 1 or more), and
y5 and y6 are each independently an integer of 1 or more.

2. The composition according to claim 1, wherein
in the formula (A1), at least one R¹¹ has a carbon chain having 4 or more carbon atoms linked to one another and the carbon chain is linked to T¹¹,
in the formula (A2), at least one of the following conditions is satisfied that at least one R²¹ has a carbon chain having 4 or more carbon atoms linked to one another and the carbon chain is linked to T²¹; and at least one R³¹ has a carbon chain having 4 or more carbon atoms linked to one another and the carbon chain is linked to T³¹, and
in the formula (A3), at least one R⁴¹ has a carbon chain having 4 or more carbon atoms linked to one another and the carbon chain is linked to T⁴¹.

3. The composition according to claim 1, wherein a mass ratio of a content of the second component to a content of the first component is 0.01 to 0.50.

4. The composition according to claim 1, wherein
in the formula (B1), R⁵ is a fluoroalkylene group, and
in the formula (B2), both R⁶ are R⁷ are a fluoroalkylene group, and L^{b1} is a single bond.

5. The composition according to claim 4, wherein
in the formula (B1), a number of carbon atoms in the fluoroalkylene group represented by R⁵ is 1 to 20, and
in the formula (B2), a sum of a number of carbon atoms in the fluoroalkylene group represented by R⁶ and a number of carbon atoms in the fluoroalkylene group represented by R⁷ is 2 to 40.

6. A substrate with a surface layer, which comprises a substrate and a surface formed of the composition as defined in claim 1 on the substrate.

7. A method for producing a substrate with a surface layer, which comprises forming a surface layer on a substrate using the composition as defined in claim 1 by dry coating method or wet coating method.
